(19) United States
(12) Patent Application Publication
(10) Pub. No.: US 2022/0016677 A1
(43) Pub. Date: Jan. 20, 2022

(54) CONTAINER WASH SYSTEM

(71) Applicant: CRC R&D, LLC, Kenner, LA (US)

(72) Inventors: Tom Lombard, Brookings, SD (US); Ronald H. Mains, Kenner, LA (US)

(21) Appl. No.: 17/379,683

(22) Filed: Jul. 19, 2021

Related U.S. Application Data
(60) Provisional application No. 63/220,608, filed on Jul. 12, 2021.
(60) Provisional application No. 63/174,982, filed on Apr. 14, 2021.
(60) Provisional application No. 63/121,637, filed on Dec. 4, 2020.
(60) Provisional application No. 63/106,433, filed on Oct. 28, 2020.
(60) Provisional application No. 63/053,437, filed on Jul. 17, 2020.

(51) Int. Cl. B08B 3/02; F26B 21/00; F26B 15/12; B08B 3/14; C02F 1/44; C02F 1/00

(52) U.S. Cl. CPC B08B 3/022; F26B 21/004; F26B 15/122; C02F 2103/002; C02F 1/441; C02F 1/001; B08B 3/14

(57) ABSTRACT

A container washing system may include a wash system, a drying system, and a conveying system. The conveying system may include a series of rollers to provide a path for a container to pass through the wash system and the drying system. The wash system and drying system may be housed in a containment structure, which may be mounted to a trailer thereby allowing the container washing system to be portable. The wash system may include one or more water jets for spraying water at a container carried by the conveying system, and the drying system may include one or more air nozzles for directing moving air at the container carried by the conveying system. The conveying system may be motorized to automatically convey the container through the wash system and the drying system. The water may be reclaimed, filtered, and recirculated through the wash system.

### RELATED APPLICATIONS

This application claims the benefit under 35 U.S.C. § 119(e) of U.S. Provisional Application No. 63/220,608 filed Jul. 12, 2021, and of U.S. Provisional Application No. 63/174,982, filed Apr. 14, 2021, and of U.S. Provisional Application No. 63/121,637, filed Dec. 4, 2020, and of U.S. Provisional Application No. 63/106,433, filed Oct. 28, 2020, and of U.S. Provisional Application No. 63/053,437, filed Jul. 17, 2020, the disclosures of which are incorporated, in their entirety, by this reference.

### BACKGROUND

Commercial tote containers are used to ship and store numerous types of materials. For instance, plastic pellets, agricultural products, and recyclables may be shipped to and from end users and stored in bulk containers. Some of these commercial tote containers may be openable at the top, and in some cases, have a hopper that can dispense materials toward the bottom of the container.

The containers may be shipped long distances and stored for extended periods of time, which can lead to dirt and dust build-up on the containers, along with other contaminants that affect the appearance and/or cleanliness of the container. The containers are typically reused numerous times, and a customer does not want to receive a container where the container arrives dirty or otherwise unsanitary.

Consequently, there is a need for a system that can efficiently and effectively clean a commercial tote container. While there are known container washing systems currently available, they lack portability, efficiency, and the ability to process numerous containers at a variety of locations.

Accordingly, it would be advantageous to provide a system that is economical, easy to use, able to processes numerous types and styles of containers, and addresses the other aforementioned deficiencies. These and other features that will become apparent from the following description.

### SUMMARY

According to some embodiments, a method of washing a container providing a wash system comprising a plurality of water jets carried on a wash frame and disposed within a first containment structure carried on a first trailer; providing a drying system comprising a plurality of air jets carried on a drying frame disposed within the first containment structure; providing a conveying system configured to convey a container through the wash system and the drying system; locating the first trailer at a loading dock of a building to facilitate placing a container to be washed from inside the building onto the conveying system; and placing a container to be washed onto the conveying system and conveying the container through the wash system and the drying system on the conveying system; and wherein the wash system sprays the container to be washed with the plurality of water jets and wherein the drying system directs moving air at the container to be washed after the wash system sprays the container.

The method may further include moving a spray nozzle from a first location outside the container to be washed to a second location inside the container to be washed and spraying a cleaning fluid through the spray nozzle to clean the inside of the container to be washed. For instance, a spray nozzle can be situation to allow a container to pass thereby, and at the right moment, the spray nozzle can be inserted into the container and spray cleaning fluid about the inside of the container to clean the inner surfaces of the container.

The method may include collecting, such as at a bottom of the containment structure, cleaning fluid that has passed through the plurality of water jets and directing the cleaning fluid to a sump. The sump may include one or more baffles to allow particulates in the cleaning fluid to settle to the bottom of the sump.

In some examples, the method includes pumping the cleaning fluid from the sump through a filtration system to result in filtered cleaning fluid. The filtered cleaning fluid may be recirculated to be used again in the wash system. In some cases, the method includes heating, with a heater, the cleaning fluid.

In some embodiments, the method includes providing an energy delivery system and coupling the energy delivery system to the wash system by one or more electrical connections and one or more fluid connections. The energy delivery system may also include one or more gas couplings, such as to provide pressurized air to the wash system and/or the drying system.

The energy delivery system may be disposed within a second containment structure and be carried on a second trailer.

In some instances, the conveying system extends from a first location outside the first containment structure, through the containment structure, and to a second location outside the first containment structure.

The method may include moving a first drying fan from a stowed location inside the first containment structure to an operating location outside the first containment structure. The first drying fan may be mounted to a frame that is repositionable to allow the fan to be moved from the stowed location to the operating location. The frame may have one or more springs to facilitate repositioning the fan.

The method may include the step of assembling the conveying system by removing portions of the conveying system from the first containment system and coupling the portions of the conveying system together outside the first containment system.

In some embodiments, the method includes the step of flipping a container to be washed from a first orientation to a second orientation. For example, where a container is in an upright orientation, the flipper may reorient the container to be upside down. In other words, the flipper may reorient the container by 180 degrees.

The method may include the step of causing the cleaning fluid to pass through a reverse osmosis system.

In some embodiments, the method includes controlling, with one or more processors, one or more of the wash system, the drying system, and the conveying system.

The method may further include the step of displaying, on a display in communication with the one or more processors, information associated with the wash system. The information associated with the wash system may include one or more of a fluid flow rate, a number of containers that have passed through the wash system over a time period, a time of operation, a fluid pressure, a gas pressure, and a fluid temperature, among other information.

In some examples, the conveying system defines an ingress path that is adjacent the loading dock to facilitate loading the container to be washed from the building to the conveying system, an intermediate path that passes the container to be washed through the wash system and the drying system, and an egress path that is adjacent to the loading dock to return the container to be washed to the building.

According to some embodiments, a container washing system may include a wash system, a drying system, and a conveying system. The conveying system may include a series of rollers to provide a path for a container to pass through the wash system and the drying system. The wash system and drying system may be housed in a containment structure, which may be mounted to a trailer thereby allowing the container washing system to be portable. The containment structure may be sized to be carried on a semi-trailer, and in some embodiments, is twenty feet long. The wash system may include one or more water jets for spraying water at a container carried by the conveying system, and the drying system may include one or more air nozzles for directing moving air at the container carried by the conveying system. The conveying system may be motorized to automatically convey the container through the wash system and the drying system. The water may be reclaimed, filtered, and recirculated through the wash system.

An energy delivery system may include one or more water tanks, water filters, air pumps, and water pumps to provide water, air, and electricity to the wash system, drying system, and conveying system. The energy delivery system may be housed in a housing that may be mounted to a trailer thereby allowing the energy delivery system to be portable.

According to some embodiments, a container washing system includes a wash system comprising a plurality of water jets carried on a wash frame; a drying system comprising a plurality of air jets carried on a drying frame; a conveying system for conveying a container through the wash system and the drying system; a containment structure for enclosing the wash system, the drying system, and at least partly enclosing the conveying system; and a wheeled trailer coupled to the containment structure for supporting and carrying the containment structure. The containment structure may be mounted on, and coupled to, the trailer and maintained on the trailer during use.

In some cases, two or more of the plurality of water jets are coupled together by a linkage, and may be operated by a motor to oscillate the two or more of the plurality of water jets.

In some embodiments, the conveying system includes a plurality of rollers to convey the container through the wash system and the drying system. The rollers may be journaled at their ends to allow a container to move along the rollers.

In some cases, the plurality of rollers define a negative slope in a feed direction to encourage the container to move along the conveying system by gravity. In other words, a subsequent roller is lower than a previous roller, which allows a container to move from roller to roller with the assistance of gravity. In some instances, a motor may drive one or more of the plurality of rollers.

In some cases, the conveying system may include a conveyor belt to convey the container through the wash system and the drying system.

In some embodiments, the conveying system is longer than the containment structure and extends beyond one or more ends of the containment structure.

In some instances, the conveying system defines a path for conveying the container through the wash system and the drying system, the path being formed of two or more pieces, each of the two or more pieces defining a length of the path, and the two or more pieces are selectively attachable to define a length of the path that is longer that the containment structure. For example, there may be two or more sections of the conveying system that may be linked together to provide a conveying system that is longer than the containment structure. In some cases, the two or more sections of the conveying system are configured to be stored within the containment structure when the container washing system is being transported on the wheeled trailer.

According to some embodiments, an energy delivery system includes a water storage tank; a water filter; one or more air pumps; and one or more water pumps. The energy delivery system may be housed within a housing, and the housing may be configured to be supported and carried by the wheeled trailer.

The energy delivery system may be coupled to the containment structure to supply water, air, and electricity to the wash system, drying system, and conveying system.

According to some embodiments, a box washing system includes a wash system;

a drying system; and a conveying system for moving a box through the wash system and the drying system.

A wash frame may have two vertical supports and one horizontal support, the two vertical supports and the horizontal supporting carrying one or more water jet nozzles.

A drying frame may carry one or more air nozzles and be configured to direct flowing air to a box moving relative to the drying frame. The one or more air nozzles may be configured to oscillate to direct the flowing air in a sweeping path.

In some cases, the conveying system defines a path, and the path passes through the wash system and through the drying system. The conveying system may be configured to convey a box along the path at a rate of up to 40 ft/min.

In some cases, the wash system, drying system, and conveying system are permanently mounted to a trailer, and the box washing system may be portable.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 shows a container cleaning system, in accordance with some embodiments;

FIG. 2 shows a conveyer with water jet nozzles and air nozzles, in accordance with some embodiments;

FIG. 3 shows a conveyer and an enclosing structure for a container cleaning system, in accordance with some embodiments;

FIG. 4 shows an end view of a container cleaning system, in accordance with some embodiments;

FIG. 5 shows an energy delivery system configured for use with a container washing system, according to some embodiments;

FIG. 6 shows an energy delivery system configured for use with a container washing system, according to some embodiments;

FIG. 7 shows a container cleaning system with external driers, in accordance with some embodiments;

FIG. 8 shows a piping and electrical schematic diagram of a container cleaning system, in accordance with some embodiments;

FIG. 9 shows an energy delivery and control system, in accordance with some embodiments;

FIG. 10 shows a container wash system manifold, in accordance with some embodiments;

FIG. 11. shows a container wash system first end showing an entry into the washing containment structure, in accordance with some embodiments;

FIG. 12 shows a plurality of mounted drying fans, in accordance with some embodiments;

FIG. 13 shows a container wash system with a conveying system, in accordance with some embodiments;

FIG. 14 shows a container wash system with a conveying system, in accordance with some embodiments:

FIG. 15 shows a container wash system with a conveying system, in accordance with some embodiments;

FIG. 16 shows a container flipper suitable for use with a container wash system, in accordance with some embodiments;

FIG. 17 shows a container flipper suitable for use with a container wash system, in accordance with some embodiments;

FIG. 18 shows a container wash system with conveying system, in accordance with some embodiments;

FIG. 19A shows an energy delivery system, in accordance with some embodiments; and

FIG. 19B shows an energy delivery system, in accordance with some embodiments.

FIGS. 20A, 20B, and 20C illustrate embodiments of a container wash system, in accordance with some embodiments;

FIGS. 21A and 21B illustrate embodiments of a container wash system, in accordance with some embodiments;

FIG. 22 illustrates a piping and instrumentation diagram of a container wash system showing the container cleaning system and energy delivery system, in accordance with some embodiments;

FIG. 23 illustrates an Alerts dashboard presented on a computer display for use with a container wash system, in accordance with some embodiments;

FIG. 24 illustrates a blower runtime dashboard presented on a computer display for use with a container wash system, in accordance with some embodiments;

FIG. 25 illustrates a location map presented on a computer display for use with a container wash system, in accordance with some embodiments;

FIG. 26 illustrates a Washer Overview dashboard presented on a computer display for use with a container wash system, in accordance with some embodiments;

FIG. 27 illustrates operating instructions presented on a computer display for use with a container wash system, in accordance with some embodiments;

FIG. 28 illustrates a container wash system runtime dashboard presented on a computer display for use with a container wash system, in accordance with some embodiments;

FIG. 29 illustrates a volume dashboard presented on a computer display for use with a container wash system, in accordance with some embodiments;

FIG. 30 illustrates a piping and instrumentation diagram of a container wash system showing the container cleaning system and energy delivery system, in accordance with some embodiments;

FIG. 31 illustrates an embodiment of a container wash system having a wash arm configured to clean the inside of a container in a stowed position, in accordance with some embodiments;

FIG. 32 illustrates an embodiment of a container wash system having a wash arm configured to clean the inside of a container in an intermediate position, in accordance with some embodiments;

FIG. 33 illustrates an embodiment of a container wash system having a wash arm configured to clean the inside of a container in an inserted position, in accordance with some embodiments;

FIG. 34 illustrates an embodiment of a wash nozzle that may be used with a container cleaning system, in accordance with some embodiments; and

FIG. 35 illustrates an embodiment of a wash nozzle that may be used with a container cleaning system, in accordance with some embodiments

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

Bulk containers, such as those used to transport or store agricultural seeds, or industrial tanks used to store liquid or dry matter, or industrial tanks used to store liquid or dry matter, are reusable containers that may be used to ship or store various contents. Over time, the containers become dirty or contaminated and need to be washed prior to subsequent use. In some cases, the contents of the container are treated with chemicals, thereby depositing chemicals inside the container even when the contents are emptied. In some cases, the container cleaning system described herein utilizes a closed loop fluid system. As such, the interior of the containers may be cleaned with another process or system so as to avoid the washing fluid in the closed loop fluid system from becoming contaminated. While the description mentions cleaning of bulk containers, such as totes used to transport seeds, any container can be used with the described system. The system is especially suitable for cleaning containers having crevices that are traditionally difficult to clean at a suitable speed for processing many containers efficiently.

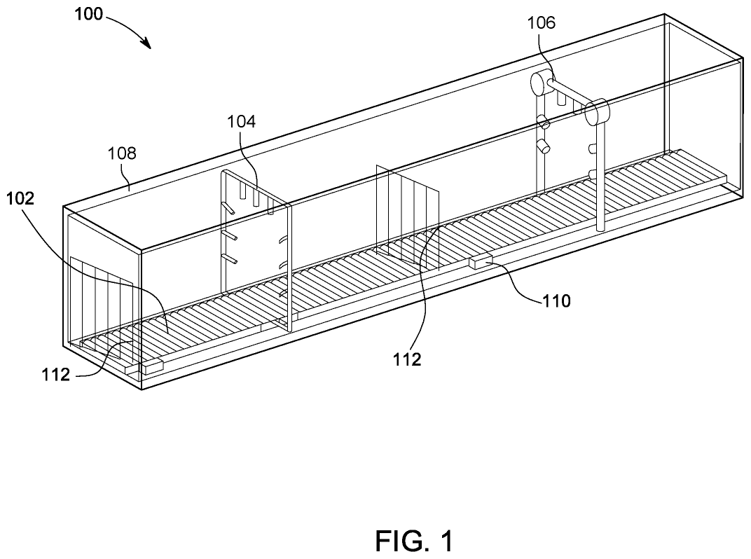

FIG. 1 shows a container cleaning system 100 having a conveying system 102, a washing system 104, and a drying system 106. A containment structure 108 may encompass part or all of the conveying system 102, washing system 104, and drying system 106.

The containment structure 108 may be open at one or more ends to allow a container to be loaded onto the conveying system 102 and to be retrieved off the conveying system 102 after passing through the washing system 104 and the drying system 106. The conveying system 102 may incorporate one or more motors 110 to aid with conveying of containers along the system 100. They conveying system 102 may be configured such that all sides of the container may be washed without obstruction by a following container.

A separator 112 may be provided between the washing system 104 and the drying system 106. In some embodiments, the separator 112 inhibits water from the washing system 104 to enter the area where the drying system 106 is located. In some instances, the separator may be one or more curtains that mount to a frame. The curtains may be made of any suitable material, such as plastic. In some cases, the curtains may be transparent or translucent so an operator can see through the cleaning system 100. The frame may be suitably sized to allow a container to pass through and in some cases is slightly bigger than the profile of the container to reduce the opening through which water may have a tendency to splash into the drying system 106 area. The frame may include solid material that extends to the supporting containment structure 108 and only provides an opening that is slightly larger than the container. A similar separator 112 may be provided at the first end of the containment structure to inhibit water from splashing outside the container cleaning system 100.

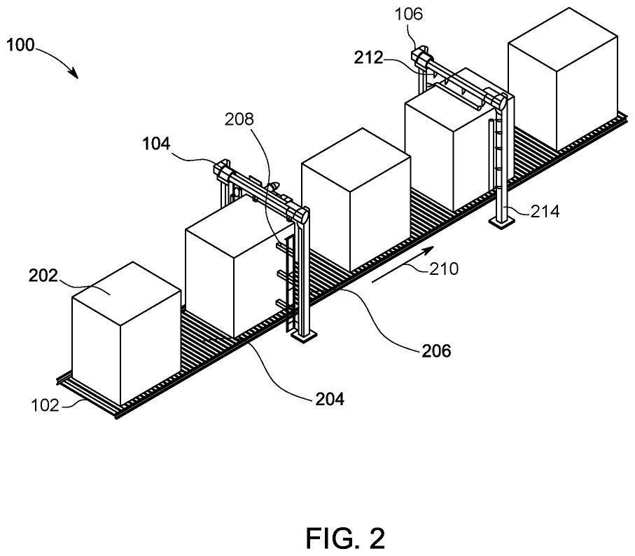

With reference to FIG. 2, the washing system 100 is shown without the containment structure. A conveying system 102, which in some cases is a system of rollers, or may be a conveyor belt that is wrapped around one or more rollers, is configured to convey one or more containers 202. As illustrated, a plurality of rollers 204 are cylindrically shaped and may be journaled at both ends to allow the rollers 204 to freely rotate about its longitudinal axis. In some cases, the rollers are free to rotate as a container 204 is carried by the conveying system 102. In some embodiments, the rollers 204 each have a longitudinal axis, and the axis of the system of rollers is coplanar. Consequently, where the rollers 204 have the same diameter, a container 202 may span multiple rollers 204 and be in contact with the multiple rollers 204 simultaneously. The rollers 204 provide a support for the one or more containers 202 and allow the containers 202 to be fed along the conveying system 102.

In some cases, one or more of the rollers 204 are driven, such as by an output from a motor, to convey a container 202 along the conveying system 102. For example, a motor may have an output shaft that provides a rotary output. The rotary output may be coupled to one or more of the rollers 204 to drive the one or more rollers 204. In some cases, a container may be in contact with a plurality of rollers 204 simultaneously, such as 2 rollers, or 4 rollers, or 6 rollers, or some other number of rollers 204. In some cases, a container may be in contact with 2 rollers that are driven, and other rollers that are free spinning. For example, a container may be in contact with 1 or 2 driven rollers, and 3 or 4 free spinning rollers.

The conveying system 102 may optionally include a conveyor belt, in which the container 202 rides on a belt that is wrapped around one or more rollers. The conveyor belt may be manually driven, such as by pushing on a container, or may be driven by one or more motors. In some embodiments, the conveying system 102 moves the containers 202 through the system 100 at a rate of up to about 400 feet per minute (6.7 ft/sec) or more. In some cases, the conveying system 102 is configured to move the containers 202 along at a rate of about 20 ft/min, or 40 ft/min, or 60 ft/min, or 80 ft/min or 100 ft/min or some other suitable feed rate.

In some embodiments, one or more driven rollers may be in communication with one or more motors. In some cases, a driven roller is directly driven by a motor. In some cases, a driven roller is coupled to a motor by a chain, belt, pulley, or some other structure to transfer the output from the motor to the roller. In some cases, one motor is coupled to multiple rollers 204 to provide a driving force to multiple rollers 204.

The washing system 104 may be supported by a wash frame 206. The wash frame may be any suitable structure and formed of any suitable material, such as any of a number of metals, plastics, composites, or a combination of materials.

The wash frame 206 may support one or more water jet nozzles 208 that are configured to spray a jet of cleaning fluid, such as water, onto a container 202 as it passes through the wash system 104.

In some cases, the wash frame 206 is be configured to carry the wash fluid. In some embodiments, the wash frame 206 supports one or more fluid hoses for delivering the wash fluid to the water jet nozzles 208. The wash frame 206 may use clips, hooks, channels, straps, or some other structure for supporting the fluid hoses in place.

The wash frame 206 may be connected to the containment structure, and may be connected to the floor, one or more walls, or the ceiling, or a combination. In some embodiments, the wash frame may be omitted, and the water jet nozzles 208 may be connected directly to the containment structure.

The wash nozzles 208 may be any suitable nozzle, and in some cases are configured to spray a high-pressure water jet. The nozzles may be spaced about the conveyor system 102 and positioned to aim at three sides, four sides, five sides, or six sides of the container 202 carried by the conveying system 102. That is, nozzles may be positioned to aim a water jet at all sides of a container 202, or in some cases, fewer than all sides of the container. For example, one or more water jets 208 may be positioned below the conveying system and aimed to shoot upwardly through the conveying system 102 in order to spray the bottom of the container 202. Some of the water jet nozzles may be aimed perpendicular to the direction of travel 210 of the conveying system 102. One or more nozzles 208 may be aimed oblique to the direction of travel 210 of the conveying system 102. In some cases, a container 202 may be placed on the conveying system 102 at an angle, such that a nozzle aimed perpendicular to the direction of travel 210 of the container 202 will spray two sides of the container, or if a nozzle is aimed at a corner of the container, will spray three sides of the container.

The drying system 106 may be equipped with one or more air nozzles 212 configured to direct a stream of air across the containers 202. The air nozzles 212 may be any suitable air nozzle, and in some cases, may be air knife nozzles in which a supply of air is directed through a small cross-sectional outlet which greatly increases the velocity of the air as it passes through the air nozzle 212. Similarly to the water jet nozzles 208, the air nozzles 212 may be carried by a dryer frame 214. The dryer frame 214 may be coupled to the containment structure. The dryer frame 214 may carry one or more air hoses to deliver pressurized air to the air nozzles 212. In some cases, the dryer frame 214 may be omitted and the air nozzles 212 may be coupled to the containment structure.

In some embodiments, the wash frame 206, the dryer frame 214, or both may be static. That is, the frames do not move. However, in some embodiments, one or more of the wash frame 206 and the dryer frame 214 can be mounted on a swivel and configured to rotate about the container 202. For instance, the wash frame 206 may be rotatably coupled to the ceiling at a location that is above the center of the conveying system 102. The wash frame 206 may be substantially L-shaped, or U-shaped such that a horizontal member is rotatably coupled to the ceiling of the containment structure, and one or more vertical members extend downwardly from an end of the horizontal member. One or more water jet nozzles 208 may be mounted on the horizontal member or a vertical member. In use, the wash frame 206 may pivot about the rotatably coupling and the vertical member can be caused to rotate about the container thus spraying 4 vertical sides of the container with each revolution. The wash frame 206 may additionally have nozzles positioned to spray the top and/or the bottom of the container 202 as well.

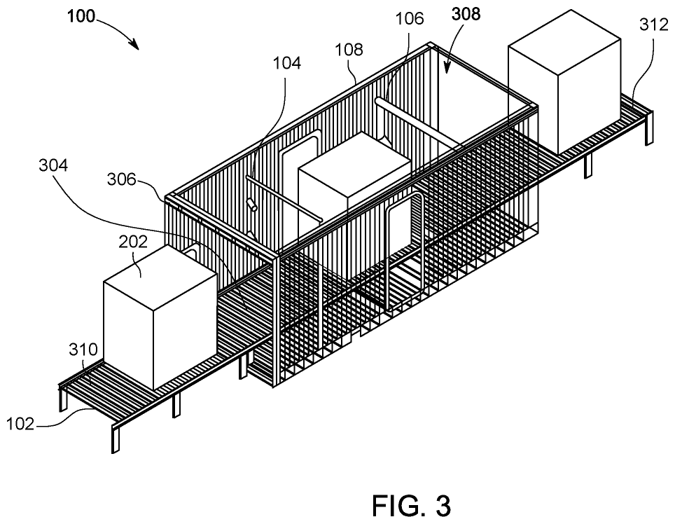

FIG. 3 shows a container cleaning system 100 with a conveyor system 102 extending through a containment system 108. The conveyor system 102 may include one or more sections of conveyor track. In some instances, the conveyor track is formed of a plurality of rollers that are journaled at their ends in a sufficient number to provide support to a container 202 placed thereon. The conveyor track may include one, two, three, or more sections of track that are selectively attachable to one another. In some instances, a first conveyor track 304 is mounted within the containment structure 108, such as by being attached to one or both sidewalls 302 of the containment structure 108. The containment structure 108 may have a first open end 306 and a second, opposing, open end 308. A second conveyor track 310 may be coupled to the first conveying track 304 and provide infeed support for containers 202. A third conveying track 312 may be coupled to the first conveying track 304 and provide outfeed support. In some embodiments, the second conveying track 310 extends through the first open end 306 and may provide infeed support for containers 202 entering the system 100. In some embodiments, the third conveying track 312 extends through the second open end 308 and provides outfeed support for containers 202 exiting the system 100. In some instances, the conveying track is formed in two sections that may be selectively coupled to extend beyond the first open end 306 and the second open end 308 to provide both infeed and outfeed support.

The conveying system 102 may be selectively moved between a transport position, and an operating position. The transport position may allow the one or more sections of the conveying track to be stored inside the containment structure 108. The operating position may be as illustrated in any of FIGS. 1-4.

In some cases, one or more sections of the conveying system 102 are sloped by an amount to encourage a container 202 to pass through the system 100 by gravity. For example, one or more sections of the conveying system 102 may have a slope of about 1° to about 10° with respect to horizontal. In some cases, the slope is from about 2° to about 5° . In some cases, the slope is about 3° or 4° or some other slope that encourages the containers 202 placed on the conveying system 102 to slide along the conveying system 102 by gravity. In some cases, the gravity feed conveying system 102 may be assisted by one or more driven rollers that convey the containers 202 through the system 100.

The containment structure 108 may be of any suitable size and shape, although in some embodiments, the containment structure 108 is configured to fit on a trailer for easy transport and portability. In some embodiments, the containment structure 108 is formed of steel, but may be formed of any suitable material, including polymers, other types of metal, or combinations of materials. In some cases, the containment structure 108 is dimensioned about 20 ft long, 8 ft wide, and about 8 feet 9 inches tall. Of course, other sizes are possible and are contemplated. For example, the containment structure 108 may be 10 feet long, 15 feet long, or 45 feet long, or some other length to provide a containment for the wash system 104 and the dryer system 106 within the containment structure 108.

According to some embodiments, the containment structure 108 can be selectively mounted to a trailer and made portable by hauling the containment structure 108 to a job site. In some embodiments, the conveyor system 102 can be set up to extend the conveyor system 102 beyond the first open end 306 and the second open end 308. The wash system 104 and the dryer system 106 can be hooked up to respective pumps and compressors to supply pressurized water and air. In some embodiments, the containment structure 108 remains on the trailer while in use, while in other embodiments, the containment structure 108 is removed from the trailer and placed on the ground or onto another mount for use.

In some embodiments, the conveyor system 102 is fully contained within the containment structure 108, such as is illustrated in FIG. 1. For instance, the conveyor system 102 may be shorter than the containment structure length 108. In order to set up the system for use, a first door is opened to expose the first open end 306 and a second door is opened to expose the second open end 308. The first and second doors may be roll-up doors, swinging doors, or some other suitable type of door.

One or more water hoses may be coupled to the containment structure. For example, a water supply hose may be coupled to the containment structure and provide water to the wash system 104. A water return hose may similarly be coupled to the containment structure to return water to a circulation pump. In some cases, water exiting the nozzles of the wash system 104 is allowed to pool at the bottom of the containment structure, where a drain, collector, sloped drip pan, or some other structure allows the water to be collected by the return hose and returned to a pump, tank, or recirculated. Of course, the used water can be routed to the sump, a settling tank, or directly to a filter, such as a micron filter before going to a storage tank. In some cases, a water collector is a sloped structure that allows water to be funneled, such as by gravity, toward the return hose inlet. In some embodiments, a first water tank supplies water to the wash system, and a second water tank collects dirty water. The water from the second water tank may be filtered and returned to the first water tank.

In some cases, the wash system 104 defines a closed water system in which the water used by the wash system 104 is recirculated and recycled and used to wash numerous containers 202.

One or more air hoses may be coupled to the dryer system 106. The air hoses may be operatively coupled to one or more air compressors or fans that provide air to the dryer system 106, which in turn, directs the air through nozzles at the containers 202 within the system 100.

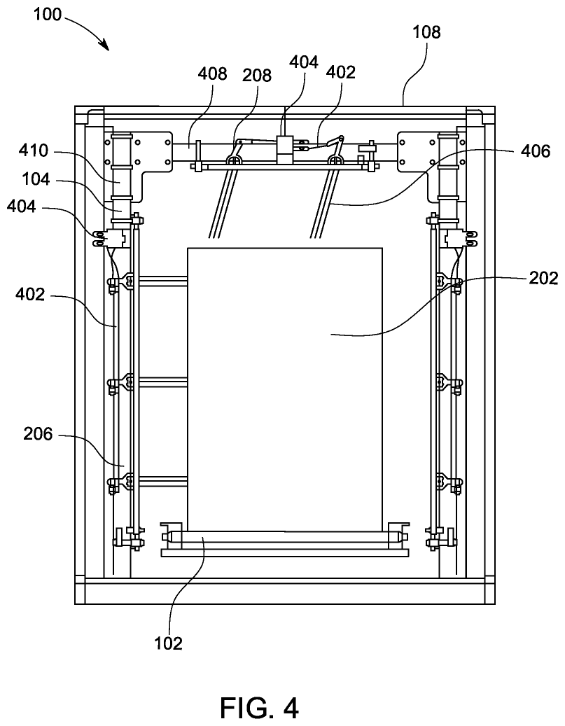

FIG. 4. illustrates an example of the wash system 104 from an end view through the first open end of the containment structure 108. The conveyor system 102 provides a path for a container 202 to travel past one or more nozzles 208. The one or more nozzles 208 may be carried by a wash frame 206 and may be coupled to allow the one or more nozzles 208 to oscillate. In some instances, two or more of the nozzles 208 are mechanically coupled together by a linkage 402 and may be driven by a motor 404 to cause the nozzles 208 to oscillate in a sweeping motion to direct the water jet 406 across the container 202. In some cases, one or more nozzles 208 arranged on a top horizontal member 408 of the wash frame 206 are coupled together and oscillate together. Similarly, one or more nozzles 208 located on a vertical support member 410 of the wash frame 206 may be mechanically coupled together by a linkage 402 and may be driven simultaneously by a motor 404 and caused to oscillate.

In some cases, the dryer system is configured similarly to the wash system, such that the air nozzles are configured to oscillate to direct compressed air across the surface of the container 202.

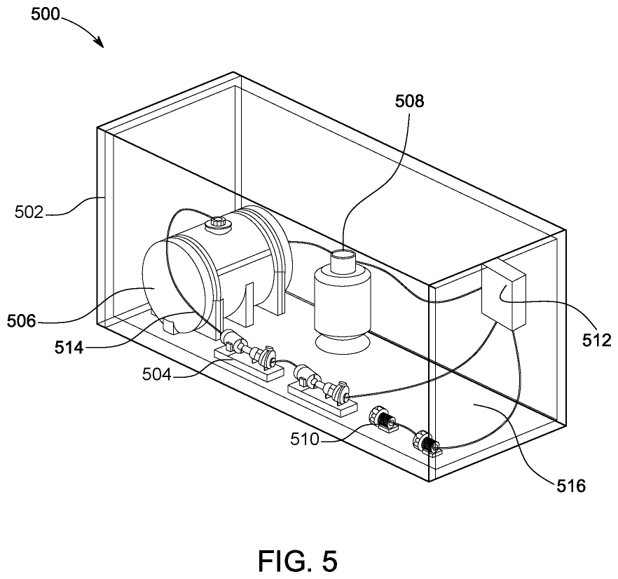

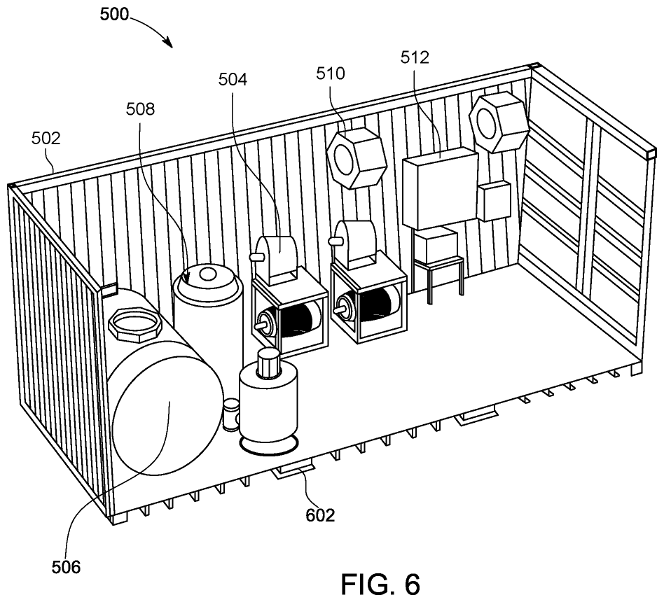

FIGS. 5 and 6 illustrate examples of an energy delivery system 500 configured for use with the container washing systems 100 described herein. The energy delivery system 500 may be configured with a housing 502 that holds the components of the energy delivery system 500. The housing 502 may be similar to the containment structure 208 of the container washing system 100. In some cases, the housing 502 is a 20-foot long steel container that is configured to be trailer-mounted for easy transport. In some cases, the housing 502 may be a 10-foot long container, a 15-foot long container, a 40-foot long container, or some other suitable dimension, and in some cases, the housing 502 may be located inside, adjacent to, or on top of, the containment structure 108.

In some embodiments, the containment structure and the housing 502 may be carried on a single trailer. In these cases, the length of the containment structure and the housing 502 may combine to be about forty feet. In some cases, each of the containment structure and the housing 502 are about twenty feet long.

The housing 502 may be configured to carry and store one or more pumps 504, water tanks 506, water filters 508, and air pumps, fans, or compressors 510. As used herein, an air pump is any device that is capable of moving air through a forced draft, and includes, without limitation, fans, air compressors, blowers, temperature differentials, among others. A control panel 512 may be mounted within the housing to allow a location to couple the various components of the energy delivery system 500 to the container cleaning system 100.

In some cases, the water storage tank 506 has a volume on the order of about 520 gallons. The actual volume of the water storage tank 506 is not critical, and is a design choice based upon the intended throughput, the level of contaminants on the containers, and the type of contaminants on the containers. The water filter 508 is coupled to the water storage tank 506 through one or more hoses. A water supply hose 514 is coupled to the water storage tank 506 and is in fluid communication with one or more pumps 504. The pumps 504 draw water from the water storage tank 506 and send it to the control panel 512, which may contain one or more water fittings that can be selectively coupled to the wash system 104 for providing pressurized water to wash a container 202.

The water pumps 504 may be any suitable water pump, and in some embodiments are one or more pumps that provide a flow rate on the order of 36 or 40 gal/m, and at a pressure of up to 1000 psi.

As described, the water used to wash the containers 202 can be collected in the containment structure and returned to the water storage tank 506 after passing through a water filter 508. The water filter 508 may be configured to filter out particulate matter, such as dirt, plant based material, or chemical contaminants in the reclaimed water. In some cases, one or more filters are used to filter the used water, and may include, without limitation, one or more of a basket filter, a mesh filter, a sand filter, a media filter, a cartridge filter, or any suitable filter or combination of filters.

The one or more air pumps 510 may be configured to provide air through an air delivery hose 516 to the control panel 512, which may include a coupling to allow the air supply to be delivered to the drying system 106 to supply compressed air to the drying system 106. The air pumps 510 may draw in air from the environment and the drying system 106 may expel the air to the environment which may pass through a filter, such as a HEPA filter, prior to being expelled into the environment.

The control panel 512 may include one or more controls that provide power to the components of the energy delivery system 500, and one or more controls to vary the pressure of the water pumps 504, the air pumps 510, control the conveyor system feed rate, or a combination. The control panel 512 may further provide feedback to a user, such as indicators associated with the one or more pressures, the volumetric flow rate, container throughput, conveyor speed, recirculation circuits of the water, contaminants in the water, and more. The control panel may transmit feedback to a user via WiFi such that a remote user may review the data, which may be transmitted in near-real time, or may be stored for later review and/or analysis. As used herein, the term “near-real time” is a broad term and is used to mean a transmission that happens as fast as practicable taking into account system latencies within and transmission times either wirelessly or wired. According to some embodiments, a portable power source, such as a generator, may be provided as part of the system, or as a separate generator unit that can be delivered, or carried by a trailer with the system. In some cases, a portable generator may provide up to about 100 kW and be configured to provide power to the energy delivery system 500 and the container wash system 100.

The energy delivery system 500 may be coupled to the container wash system 100, by one or more electrical cables to supply electricity, and one or more hoses to supply air and water. The housing 502 may be configured with skids 602 that may allow the housing 502 to be mounted, or moved, such as by lifting the housing 502 with a forklift, such as for positioning on a trailer, or on the ground.

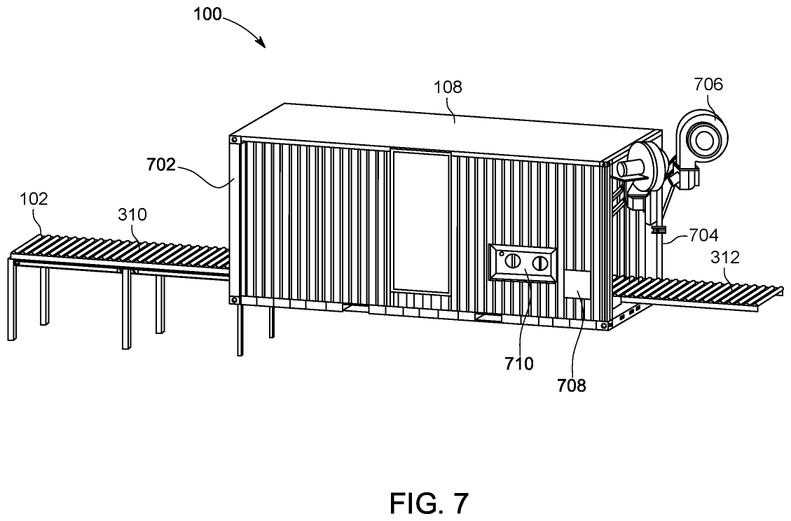

With reference to FIG. 7, a container cleaning system 100 is shown having a containment structure 108, such as that previously described herein, and a conveying system 102. The conveying system 102 may include a first conveying track located inside the containment structure 108 which may be configured to convey a container from a first end 702 of the containment structure 108 to a second end 704 of the containment structure. A second conveying track 310 may extend from the first end of the containment structure 108 to provide infeed support. A third conveying track 312 may extend from the second end 704 of the conveying structure to provide outfeed support. In some cases, the first, second, and third conveying tracks may be formed as a single conveying track that can be selectively positioned to extend from the first end 702 and second end 704. For example, the second conveying track 310 may telescope from the first conveying track from a stored position in which at least a portion of the second conveying track 310 is positioned above or below the first conveying track, and can be stored entirely within the containment structure 108. During a setup procedure, the second conveying track 310 can be selectively extended so that at least a portion of the second conveying track 310 is located outside of the containment structure 108. The third conveying track 312 may be similarly configured, such as to be selectively positionable between a stored position in which the third conveying track 312 is located entirely within the containment structure, and an operating position in which at least a portion of the third conveying track 312 is positioned outside the containment structure 108. In some uses, the containment structure 108 remains mounted on a trailer during use, and the conveying system 102 may include one or more supports that contact the ground to provide support to elevate the conveying system 102 to provide a substantially horizontal pathway through the container cleaning system 100. As used herein, substantially horizontal means that the conveying system is within 10 degrees of level.

In some embodiments, the container cleaning system 100 includes one or more fans 706, such as for drying a container. Some embodiments may include one or more fans that can be positioned outside the containment structure 108. As described previously, one or more fans can be positioned inside the containment structure 108, or may be provided in the energy delivery system and pressurized air may be provided to the container cleaning system 100 through one or more air hoses. As illustrated, some embodiments utilize one or more fans positioned outside the containment structure 108 in an operating position. The fans may be generally directed toward the third conveying track 312 to blow air to a container being carried thereon. The one or more fans 706 may be selectively moveable between a stored position, in which the one or more fans 706 are located entirely within the containment structure 108, and an operating position in which at least a portion of the one or more fans 706 is located outside the containment structure 108. By allowing the one or more fans 706 to extend outside the containment structure 108, the overall length of the container cleaning system 100 is elongated and provides additional time and opportunity to thoroughly wash and dry the containers with a suitable throughput speed and efficiency.

In some cases, the fans 706 and/or blowers used in the drying system delivery drying air with sufficient force to vibrate the containers, which further helps to remove water from the washed containers. In addition, the conveying system may include one or more shakers configured to shake the containers on the conveying system to aid in shedding water, which increases the effectiveness of the fans and blowers in drying the washed containers.

The containment structure 108 may include one or more access panels, such as an electrical access panel 708 and an airflow access panel 710. The electrical access panel may include one or more electrical receptacles, such as for receiving electricity. Electricity to the container cleaning system 100 may be provided from any suitable source, and in some cases, is provided by the energy delivery system through one or more electrical cables. Electricity may also be provided, in the alternative or in addition, by an electrical cord plugged into an electrical outlet at the location of operation of the container cleaning system 100. In some embodiments, a generator may provide power to the system. In some examples, a portable generator may be used to provide electrical power for the energy delivery system 500 and/or the container wash system 100. The generator may be any suitable generator, and my run on any suitable fuel, such as gasoline, natural gas, propane, and the like, and may provide up to about 100 KW of electricity to power the energy delivery system 500 and/or the container wash system 100.

The airflow access panel 710 may include one or more locations to receive an air hose, such as from the energy delivery system. One or more air hoses may be operatively coupled to one or more fans of the energy delivery system and the air hoses may supply air from the fans to the container cleaning system 100. As described herein, the air may be provided to an air manifold that distributes the air to nozzles that directly the air toward a container within the container cleaning system 100, such as for drying the container within the containment structure 108. In some cases, a container within the containment structure may pause at one or more locations during a drying cycle to allow the air sufficient time to pass over the container to adequately dry the container.

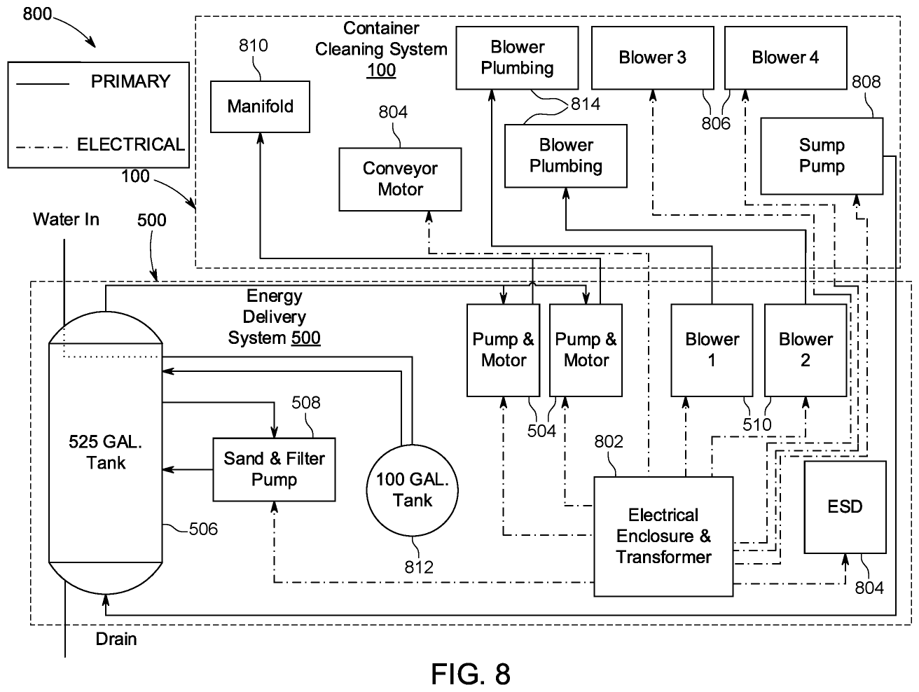

FIG. 8 illustrates a piping and electrical diagram 800 for the energy delivery system 500 and the container cleaning system 100. As described, the energy delivery system 500 and the container cleaning system 100 are housed in separated structures, in some embodiments. For example, each system may be housed within a corrugated container that can be mounted, transported, and operated upon a trailer configured to be pulled by a truck. In some cases, the energy delivery system 500 and the container cleaning system 100 may be conveyed by a single truck, and may be mounted on one or two trailers being conveyed by the truck. In some cases, the energy delivery system 500 and the container cleaning system 100 are carried on separated trailers and conveyed by separate trucks.

The energy delivery system 500 can be operatively coupled to the container cleaning system 100 prior to use, such as by coupling one or more electrical cables, air hoses, and/or water hoses.

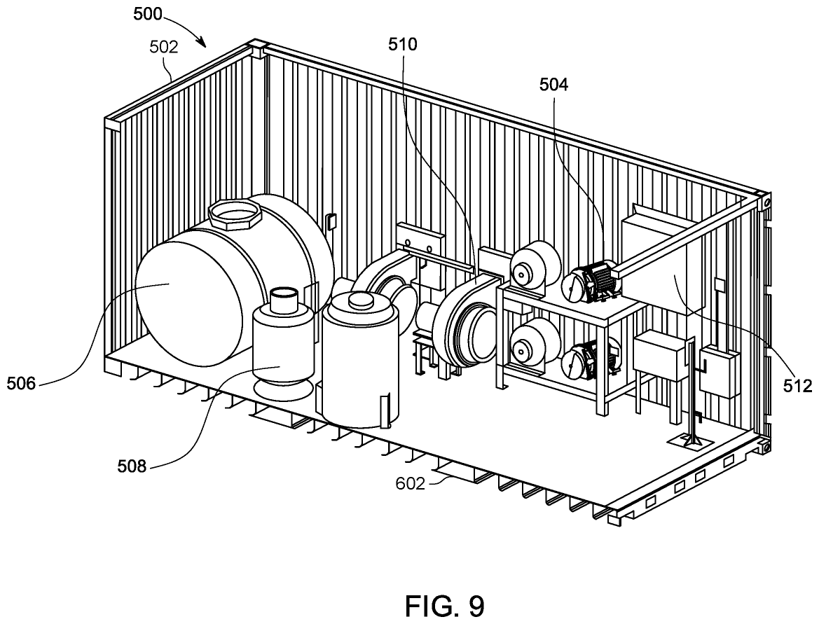

With additional reference to FIG. 9, the energy delivery system 500 may contain an electrical enclosure and transformer 802 that receives and/or distributes electrical power to the components of the energy delivery system 500 and the container cleaning system 100. The electrical enclosure and transformer 802 is operatively coupled to an ESD 804, that provides control inputs to the electrical enclosure and transformer 802, and may include one or more switches to control the various components, one or more readout displays, and one or more controls to vary the operation of one or more components of the described systems.

The electrical enclosure and transformer 802 may be operatively coupled to one or more components of the energy delivery system 500 and/or the container cleaning system 100. For example, the electrical enclosure and transformer 802 may be coupled to one or more of more blowers 510, and/or one or more pumps or motors 504 of the energy delivery system. Similarly, the electrical enclosure and transformer 802 may be operatively coupled to one or more components of the container wash system 100, such as, for example, a conveyor motor 804, one or more blowers 806, and/or a sump pump 808.

The ESD 804 can be used to control the components listed or described above, such as for increasing or decreasing blower fan speed, water pressure, and the like. In some embodiments, one or more pumps 504 provide water from the water tank 506 to a water manifold 810 of the container cleaning system 100, as described herein. The water manifold may carry one or more nozzles to spray the water within the container cleaning system 100.

Once water is sprayed in the container cleaning system 100, gravity will cause the water to fall to the bottom of the containment structure and pool. In some embodiments, the floor of the containment structure may be sloped to encourage the water to flow to a predetermined location where it can be fed by a pump, such as a sump pump 808, back to the energy delivery system 500 to be filtered through a filter 508 and reused in the wash system. The water may be pumped through one or more filters, including a basket filter, a sand filter, a cartridge filter, or any other suitable filter or combination of filters before being reused in the wash system. A storage tank 812 may store additional water, may be used as part of the filtration process, and may contain additional filters, such as charcoal filters, a reverse osmosis system, and may alternatively or additionally include a heater to heat the water circulating throughout the system. The storage tank 812 may be in communication with the water tank 506 and may store clean fluid, dirty fluid, or be used for some other purpose.

The filter 508 may be any suitable filter using any type of filtering media. In some cases, the filter 508 is a sand filter as is known in the art. The sand filter is effective at removing particles from the water and can be cleaned by reversing the flow direction through the filter and disposing of any particulates filtered out by the sand. While example embodiment utilize water as a cleaning fluid, it should be appreciated that any suitable cleaning fluid may be used, and any suitable cleaning solution may be mixed with the cleaning fluid, such as soap mixed within the water to clean, decontaminate, odorize, or provide some additional feature or benefit to the container cleaning system 100.

In some embodiments, one or more fans 806 or blowers are provided within the container cleaning system 100 as described herein, and one or more air pumps 510 may be provided in the energy delivery system 500. Each of the fans 806 and air pumps 510 may be identical units that are configured to pass air over a container that has been washed to blow off water and dry the container. The air pumps 510 may be coupled to the container cleaning system 100 by air hoses or pipes that direct air from the air pumps 510 to the containers on the conveyor system. In some cases, the air pumps 510 deliver pressurized air through blower plumbing 814 that may include one or more air manifolds that directs pressurized air to one or more blowers, nozzles, air knives, or other suitable air outlet.

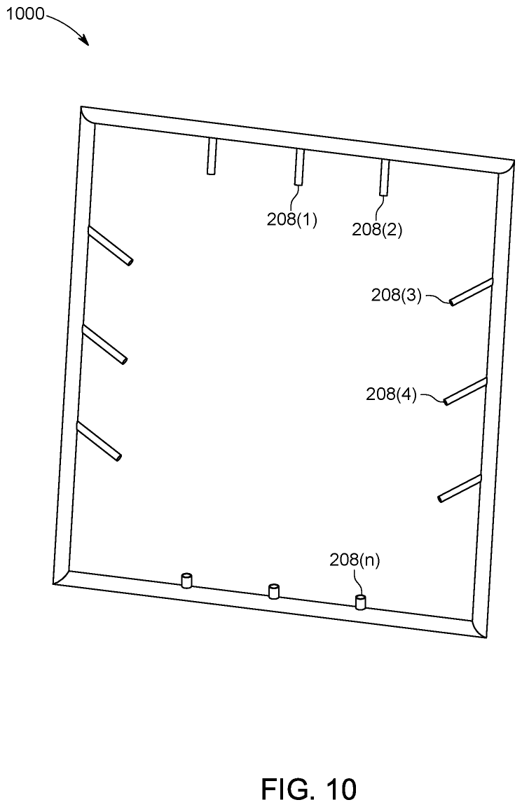

FIG. 10 illustrates a water manifold 1000 that may form part of the washing system 104. The water manifold 1000 may be in fluid communication with the one or more pumps 510 of the energy delivery system 500. The water manifold 1000 may further include one or more exits for the water provided by the pumps 510. The exits may further include water jet nozzles 208 (e.g., 208(1), 208(2), 208(3), 208(4), 208(n)) that restrict water flow and provide for a jet of water exiting the water manifold 1000. In some embodiments, the water jet nozzles 208 are configured to oscillate, rotate, translate, or a combination. In some embodiments, the water jet nozzles 208 may be static, may oscillate, or may be configured as a combination of moving and non-moving water jet nozzles. There may be any number of water jet nozzles 208, such as from 208(1) to 208(n). The water manifold 1000 may be carried by any suitable structure as described herein, and may be mounted to the containment structure, or supported by a frame. In some cases, water jet nozzles 208 are disposed to spray water at 4, 5, or 6 sides of a container passing therethrough. In some embodiments, one or more water jet nozzles 208 are placed above, below, and to the side of a container traveling on the conveying system.

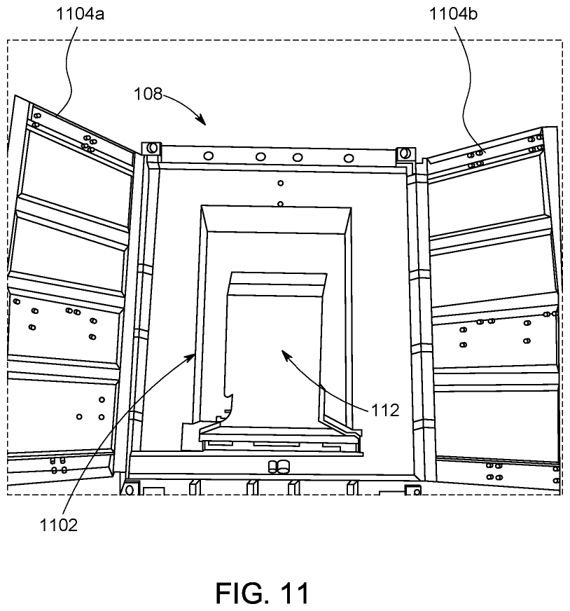

FIG. 11 shows a first end of the containment structure 108 showing an entrance aperture 1102 sized to allow a container to pass therethrough. In some cases, the entrance aperture 1102 is sized to be slightly larger than the profile of a container, which helps to reduce water splashing out of the containment structure 108 during use. A separator 112 may be provided, which may include a plurality of vertical slats that are configured to separate to allow a container to pass therethrough, and return to a vertical hanging orientation and create a separator to inhibit water from splashing form the washing system to the drying system. In some cases, a separator 112 is additionally provided to substantially cover the entrance aperture 1102 to inhibit water from splashing from the washing system to outside the containment structure 108. The containment structure may further include doors 1104 that are hingedly attached to the containment structure 108 and may be closed, such as for transporting the containment structure 108, or opened to facilitate operation.

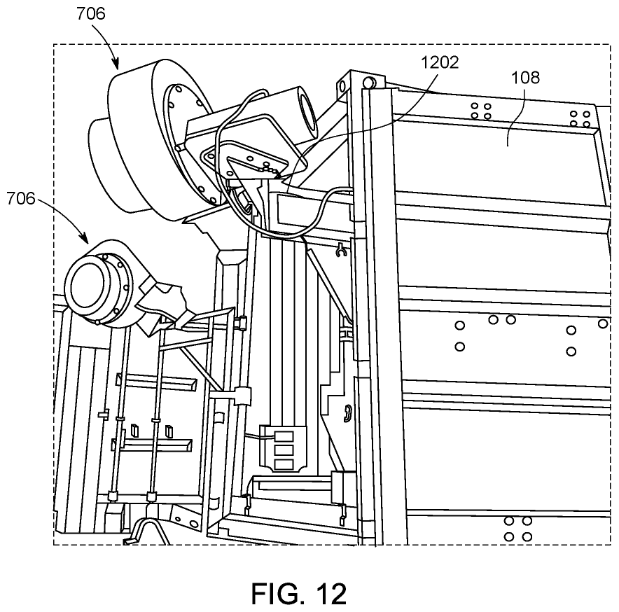

FIG. 12 shows a plurality of fans 706 mounted to the containment structure 108. As described herein, the fans 706 may be selectively moveable between a stored position in which the fans are posited completely within the containment structure 108, such as for transport or storage, and an operating position in which the fans extend outside the containment structure 108 and are generally pointed at containers passing through the containment structure 108. The fans 708 may be mounted in any suitable location and may include 2, 3, 4 or more fans configured to direct blowing air at containers moving along the conveying system. The mounts 1202 for the fans 708 may include a spring to assist with moving the fans between the stored position and operating position. The mounts 1202 may further include a clip, lock, detent, pin, fastener, knob, or other structure for maintaining the fans 708 in either the stored position, the operating position, or both. In some cases, one or more of the fans 706 blow air across the container is a direction that encourages cleaning fluid on the container to remain within the containment structure 108, such as by blowing air from outside the containment structure 108 to inside the containment structure 108.

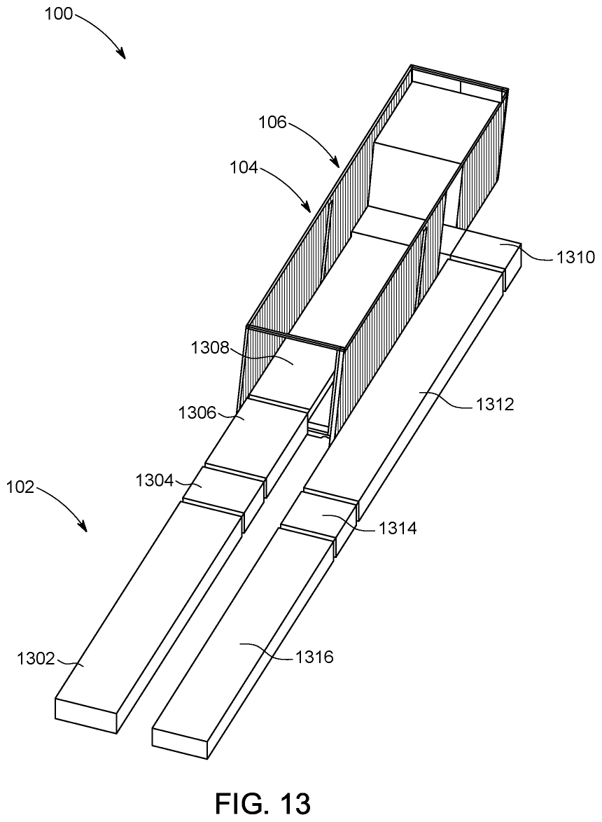

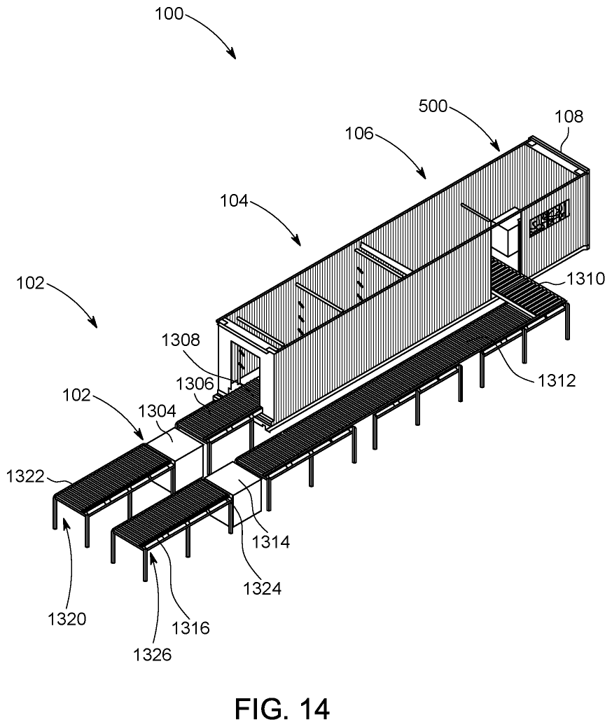

FIGS. 13 and 14 show example conveying systems 102 for use with a container washing system 100. According to some embodiments, the conveying system 102 includes a plurality of tracks that can be linked together to form the conveying system 102. For example, while not all parts are required, the conveying system 102 may include an ingress track 1302, which may be a gravity feed track, although in some cases may be provided as a motorized track. In some cases, a gravity feed track may be include rollers that are journaled and allowed to freely spin to convey a container. The gravity feed track may be inclined, such as at about 2°, or up to about 4°, 5°, 7°, 10°, or up to about 15° or more. A first flipper 1304 may be provided and configured to rotated, flip, or otherwise orient a container to position the container prior to entry to the wash system 104. A second track 1306 may include a power conveyor, which may provide input power to cause a container to enter the wash system 104. A wash system track 1308 may convey the container through the wash system 104, and in some cases, is a power driven track with one or more motors configured to move the container through the wash system 104.

In some cases, a transfer track 1310 may be provided to encourage the container to exit the wash system 104. In some cases, the transfer track 1310 extends perpendicularly to the wash system track 1308. The transfer track 1310 may be adjacent to a second flipper 1314 that may rotate, flip, or otherwise orient the container from a first orientation to a second orientation to facilitate the cleaning, drying, stacking, or transporting of the container. The flippers will be discussed in greater detail in relation to subsequent figures.

A fifth track 1316 may be provided to convey the containers after leaving the second flipper 1314. The fifth track 1316 may convey the containers via gravity, as described herein, or may include some form of powered conveyance, such as a motor.

While the description of FIG. 13 includes numbered tracks, it should be apparent that many of the components that make up the conveying system 102 are optional and may not all be present in each embodiment described herein. Furthermore, the components of the conveying system 102 need not be arranged as described, but can be arranged in many different configurations without departing from the spirit and scope of described embodiments.

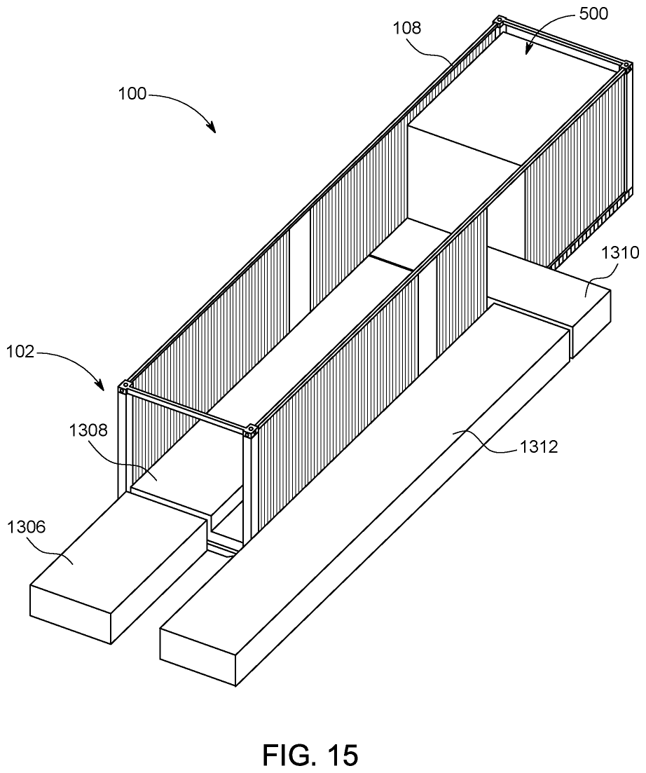

In some cases, the conveying system 102 and the wash system 104 are elevated, as shown in FIG. 15, and can be set to any suitable height. However, in some cases,

For example, with respect to FIG. 15, the conveying system 102 components may be elevated to about 44 to 48 inches off the ground. Of course, other heights are contemplated, but many loading docks are about 44 to 48 inches high, and this height makes it convenient to set up the system to a factory or warehouse with the conveying system 122 raised close to the height of a loading dock.

In use, the system 100 can be set up adjacent to a warehouse where containers are stored, shipped, and/or manufactured. The ingress conveyor 1302 may be adjacent to a first loading dock to make it convenient for containers within the building to be placed on the ingress conveyor 1302, such as by a forklift or pallet jack. The container can move through the system 100, as described herein, and returned to the building on the egress conveyor 1316. The egress conveyor 1316 may be adjacent to a second loading dock, which facilitates removal of clean containers from the system 100, such as by a forklift or pallet jack.

The ingress conveyor 1302 and egress conveyor 1316 may be adjacent to a single loading dock, or may be separated by any suitable distance to allow ingress and egress of containers through multiple loading dock bays. In some instances, the ingress conveyor 1302 has a first end 1320 adjacent the loading dock that is elevated to a first height, and a second end 1322 that is elevated to a second height, shorter than the first height. In this way, as a container is loaded onto the first end 1320, it can roll by gravity assist, to the second end, where it may be manipulated by the first flipper 1304, and/or transferred by the second track 1306 which may be motorized to guide the container through the system.

Similarly, the egress track 1316 may have a first end 1324 that is elevated above a second end 1326 to facilitate a gravity fed conveying system to return the container out of the system 100 to be collected at the loading dock. In some cases, the second end 1326 of the egress conveyor 1316 is elevated for convenient removal of a container at a loading dock, and the second end 1326 of the egress conveyor 1316 may be lower than the first end 1324 of the egress conveyor 1316 to allow a container to be returned to the loading dock by gravity. Of course, one or more of the ingress conveyor 1302 and egress conveyor 1316 may include a power feed system to guide the containers along the respective conveyors.

In some cases, one or more flippers are arranged along the conveying system. For example, a first flipper 1304 may be adjacent the ingress conveyor 1302 and may be configured to reorient a container. For example, a container may be placed on the ingress 1302 conveyer in a first orientation, and the first flipper 1304 reorients the container to a second orientation. In some cases, the container may be provided to the ingress conveyor 1302 in an upright orientation and the first flipper 1304 turns the container upside down. In other cases, a stack of nesting containers may be provided on the ingress conveyor 1302 and the first flipper 1304 may unstack the containers and place them on the second track 1306 for entry to the system 100.

Similarly, a second flipper 1324 may be disposed in conjunction with the egress conveyor 1316 for returning a container to its first orientation. For example, where containers are stored in a warehouse in an upright configuration, the system 100 may first turn a container upside down using the first flipper 1304, pass the container through the wash and dry system 100, and then return the container to an upright configuration with a second flipper 1324 as the container exits the system 100.

FIG. 15 shows a container cleaning system 100 using a more abbreviated conveyor system 102 than shown in preceding figures. For example, the conveying system 102 may include an ingress conveyor 1306, a wash conveyor 1308, a transfer conveyor 1310, and an egress conveyor 1312. With any embodiments disclosed herein, the conveying system may be substantially at ground level, or may be elevated to any suitable height, such as to be elevated similar to the elevation of the loading dock to facilitate washing containers stored in a warehouse.

In some cases, as is illustrated in FIGS. 13-15, the container cleaning system 100 and the energy delivery system 500 may be incorporated into a single containment structure 108. The containment structure 108 may be any suitable sized container, and in some cases, is about 40 feet in length, or 44 feet in length, or 45 feet in length, or some other suitably sized container.

The conveying system 102 may be moved between a stored configuration and an operating configuration. In some cases, the components of the conveying system 102 are stored within the containment structure 108 when in the stored configuration. The components of the conveying system 102 may be stored inside the containment structure 108, attached to the outside of the containment structure, or located underneath the containment structure until the system is to be set up and the conveying system 102 components are located in their operating configuration. In some cases, one or more components of the conveying system are hinged to the containment structure 108, and may be folded up and secured in place to the containment structure 108. For example, the second track 1306 may fold up and effectively be a door to close the opening to the containment structure 108.

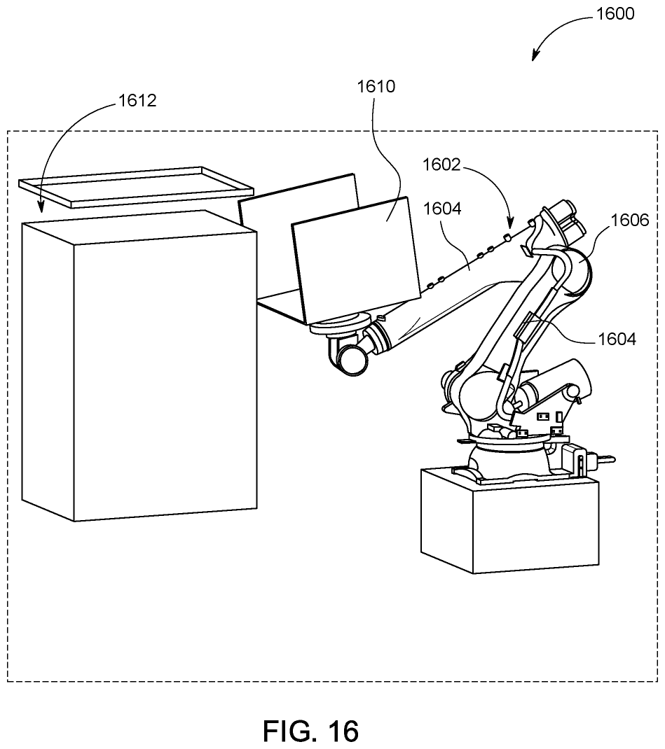

FIG. 16 illustrates one example embodiment of a flipper that can be used with a container cleaning system. The flipper 1600 includes a mechanical arm 1602 that may be a robotic arm under control of one or computers or processors of a computer. The mechanical arm 1602 may have two or more links 1604 that are coupled together at a joint 1606. The links 1604 may move about the joint, either pivotally, rotationally, and/or hingedly to extend, retract, or rotate the links relative to each other. In some cases, the mechanical arm 1600 may have three, four, six, or more degrees of freedom.

The mechanical arm 1600 may further have a manipulator 1610 that is configured to manipulate a container 1612. The manipulator 1610 may be configured to apply pressure to the sides of the container 1612 to grasp the container 1612 in order to lift, rotation, flip, or otherwise reposition the container. The mechanical arm 1600 may be positioned in line with the conveying system, or adjacent to the conveying system, or in another location that allows the flipper 1600 to reorient a container before or after it enters the container cleaning system.

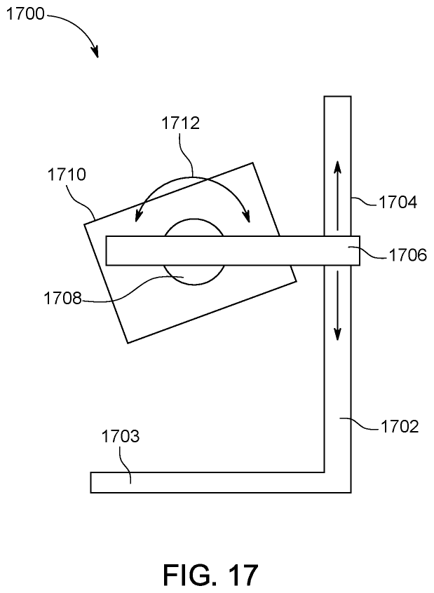

FIG. 17 illustrates another example of a flipper 1700. In this configuration, a flipper 1700 includes a frame 1702 that supports the flipper on a base 1703 and provides a vertical raceway 1704. An arm 1406 is supported b the vertical raceway 1704 and the arm is configured to move up and down the vertical raceway 1706. A pair of opposing arms 1706 may be positioned on the vertical raceway 1702. The arms 1706 may include a pair of opposing actuators 1708 configured to engage a container 1710. The actuators 1708 may be configured to rotate in one or more directions 1712 to rotate or flip a container.

The frame 1702 may incorporate a roller system at a base that facilitates containers being positioned on the flipper in between the opposing arms 1706. In use, a container is positioned on the flipper, the arms 1706 travel, if necessary, to position the actuators 1708 adjacent the container. The arms 1706, the actuators 1708, or both, move closer together to engage the container 1701. The arms 1706 may ride up the vertical raceway 1704 to lift the container off the base a sufficient distance. The actuators 1708 may cooperate and rotate to flip the container into a second orientation along one or more directions 1712. The arms may lower the container and disengage the actuators 1708, thereby permitting the container to continue along the conveying system. In some embodiments, the base 1703 may include rollers, bearings, a belt or some other system for conveying a container onto and/or off of the base. A motorized system may position the container onto the base and/or remove a container from the base to facilitate automatic conveyance and/or flipping of a container.

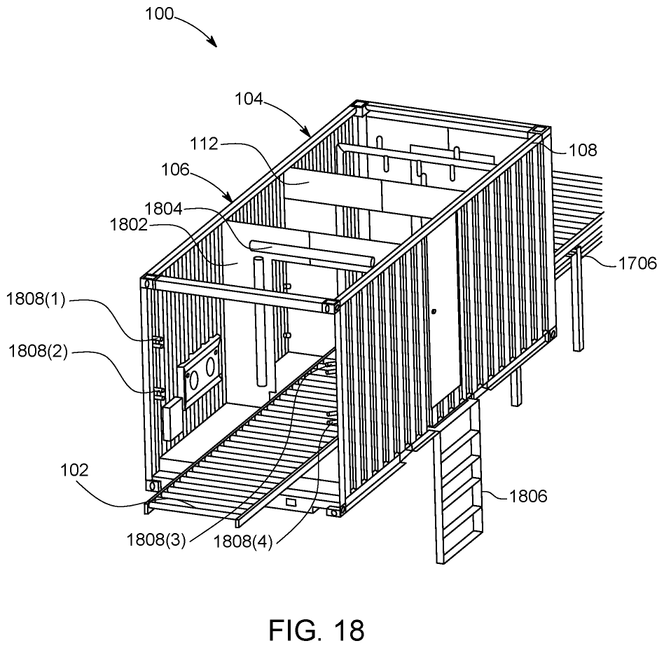

FIG. 18 illustrates an exemplary embodiment of a container wash system 100 having a conveying system 102, a wash system 104 and a drying system 106 housed within a containment structure 108. A conveying system 102 transmits a container through the container washing system 100 as described herein. In some embodiments, one or more separators 112 may be positioned between the wash system 104 and the drying system 106 and may inhibit some of the water overspray from exiting the wash system 104 and entering the drying system 106.

In some instances, the drying system 106 may be mounted on a frame 1802 that inhibits entry of wash water overspray into the drying system 106. The frame 1802 may resemble a separator 112 or may take another form configured to inhibit water from splashing into the drying system 106.

One or more air knives 1804 may be configured to direct a wall of air across the opening to the drying system 106 to further inhibit wash water overspray from entering the drying system 106. The air knives 1804 may provide an air nozzle configured to direct a sheet of high pressure air across the opening to inhibit water from crossing the sheet of high pressure air. The other components of the container washing system 100 may be as substantially describe herein and the additional separators 112 and air knives 1804 may be used with any of the embodiments described herein.

In some cases, an external ladder 1806 may be provided to allow easy entry to the container washing system 100 through any of a number of doors or openings provided through the containment structure 108. In many cases, the container washing system 100 may be mounted to a trailer, so providing a ladder 1806, or a stairway provides access to the elevated container washing system 100. While the blowers are not illustrated, mounting brackets 1808(1)-1808(4) are shown that can accommodate blowers as previously described. The blowers may be positioned to direct water from the containers into the container washing system for reclamation and recycling.

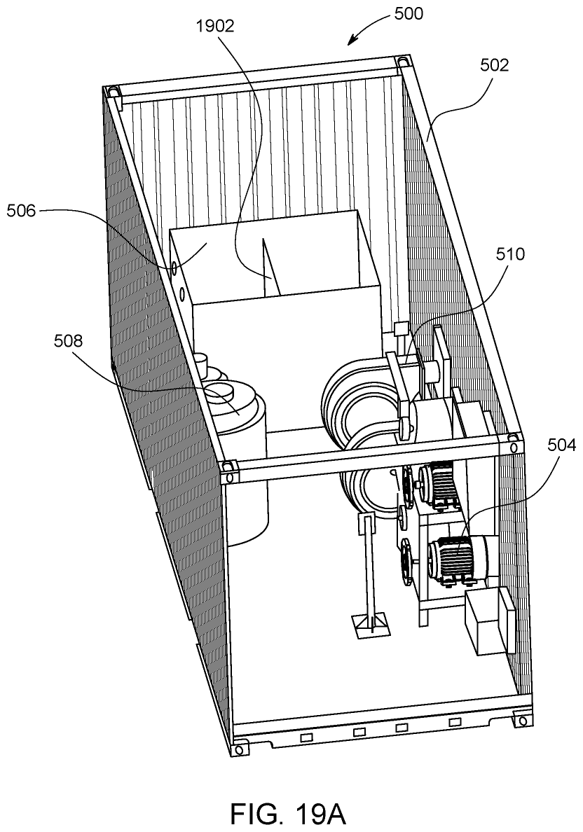

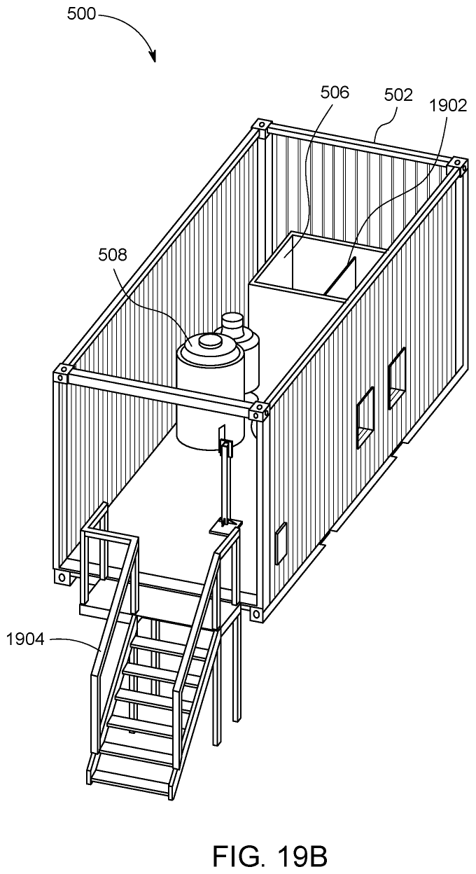

FIGS. 19A and 19B shows an embodiment of an energy delivery system 500 contained within a housing 502. The component of the energy delivery system 500 may be as substantially described herein. For example, one or more pumps 504, water tanks 506, water filters 508, and air pumps 510 may be substantially as described with respect to other embodiments. The water tank 506 may have any suitable configuration, and in some cases, has one or more baffles 1902 that separates the water tank 506 into two or more compartments. In some cases, the baffles 1902 separate the water tank into a clean storage compartment and a brown water storage compartment. Water that is recycled from the container washing system may be returned to the brown water storage compartment, and as the recycled water is cleaned through one or more water filters 508, the cleaned water is moved to the clean storage compartment, ready to be used in the container washing system. In some cases, the baffles allow sediments within the water to settle, and as the level of clean rises, it passes over the baffle into the other compartment.

As shown in FIG. 19B, in some cases, the energy delivery system 500 is elevated above ground level and may be carried by a trailer. Accordingly, in some cases, a way to access the elevated housing 502 may be provided, such as stairs 1904, a ladder, or some other access structure. In some cases, the stairs 1904 can be stored on or in the housing 502. The stairs 1904 may be foldable, extendable, or some other way of compacting the stairs for easier storage. The stairs may be repositionable between a storage configuration and a usable configuration. The stairs may be within the housing 502 for storage, and then deployed outside the housing 502 for use.

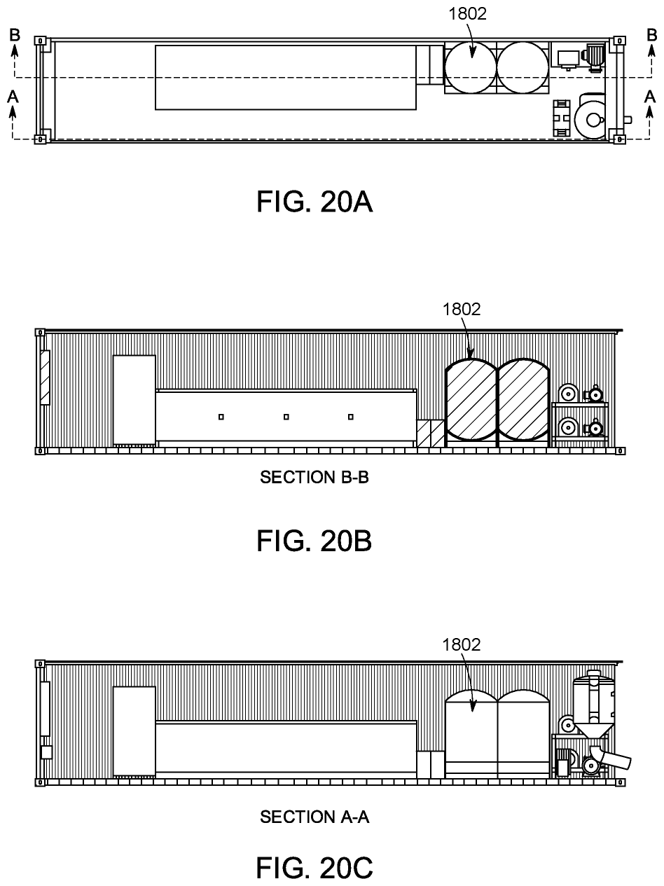

FIGS. 20A, 20B, and 20C illustrate another embodiment of a container wash system in which a filter assembly 1802 includes one, two, three, or more filters that can be plumbed to filter the reclaimed water for reuse in the container wash system. In some cases, the filters are configured to filter particles larger than 100 microns from the reclaimed water. The filters may be located within the energy delivery system, the container cleaning system, or may be mounted to the outside of one of the housings, or may be provided externally to either of the containers.

According to some embodiments, the container wash system can process more than 20 containers per hour, or more than 24, 26, 30, 35, 40, 46, 50, 60, or more containers per hour.

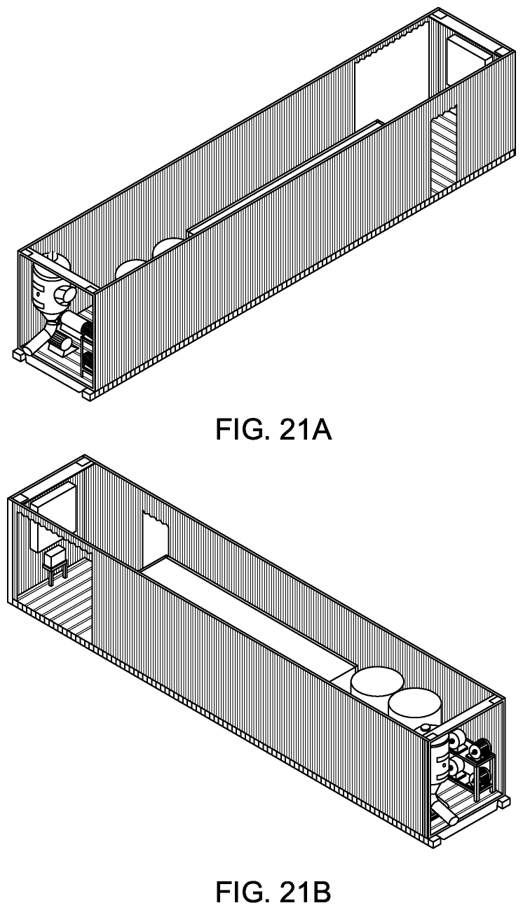

FIGS. 21A and 21B illustrate additional views of the container wash system as in FIGS. 18A-18C.

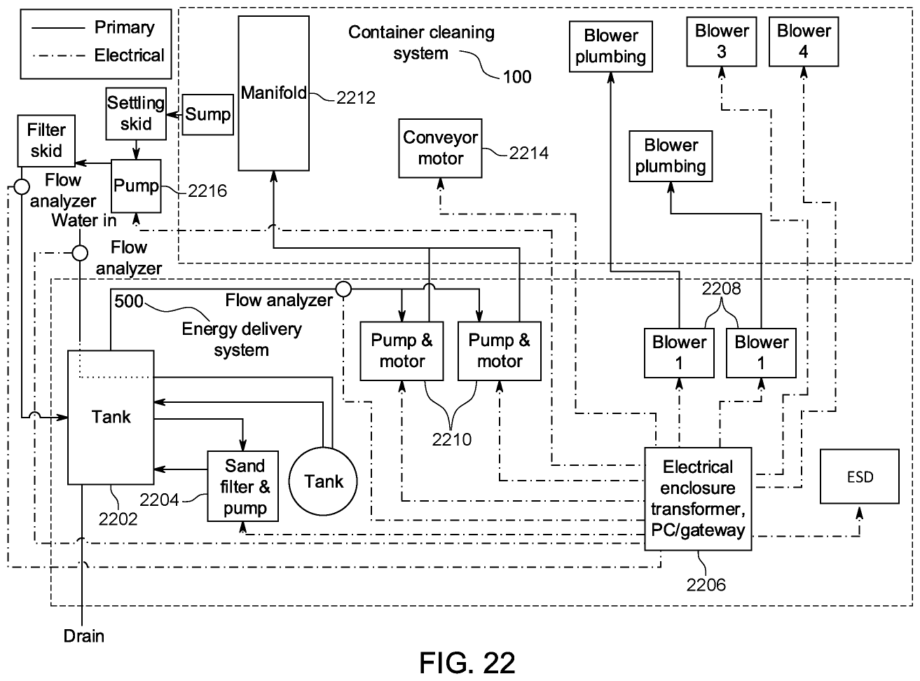

FIG. 22 illustrates a piping and instrumentation diagram according to some embodiments. The diagram shows the components of the energy delivery system 500 including a water tank 2202, filter system 2204, electrical enclosures 2206, blowers 2208, pumps and motors 2210, among others. It also shows how the components of the energy delivery system 500 are in communication with components of the container cleaning system 100. For example, the blowers 2208 may provide forced air to the container cleaning system 100, such as for drying the containers coming out of the wash system. The pumps and motors 2210 may be in fluid communication with the manifold 2212, such as for providing cleaning solutions (e.g., water) to fluid jets for cleaning the containers in the wash system. As an additional example, the electrical enclosure 2206 may be in electrical communication with components of the container cleaning system 100, such as the conveyor motor 2214, pumps 2216, and other components.

The container wash systems described herein may be under the control of one or more computing systems, such as for controlling, monitoring, receiving data from one or more sensors, and the like. For example, a computing system may be configured to monitor the container throughput through the system, the volume of water used, the volume of water reclaimed, the hours of usage, the airflow of the fans, the status of the filter systems, cleaning fluid temperature, air temperature, and may provide alerts or other indicia of system status. For example, the system may be configured to alert a user if there is a drop in water flow rate, which may be indicative of a clogged water line. An alert may be triggered based upon the cleanliness of the filter system, and may further provide a notification, and/or instructions, on how to change and/or clean the filter system.

According to some example embodiments, the systems and/or methods described herein may be under the control of one or more processors. The one or more processors may have access to computer-readable storage media (“CRSM”), which may be any available physical media accessible by the processor(s) to execute instruction stored on the CRSM. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other medium which can be used to store the desired information and which can be accessed by the processor(s).

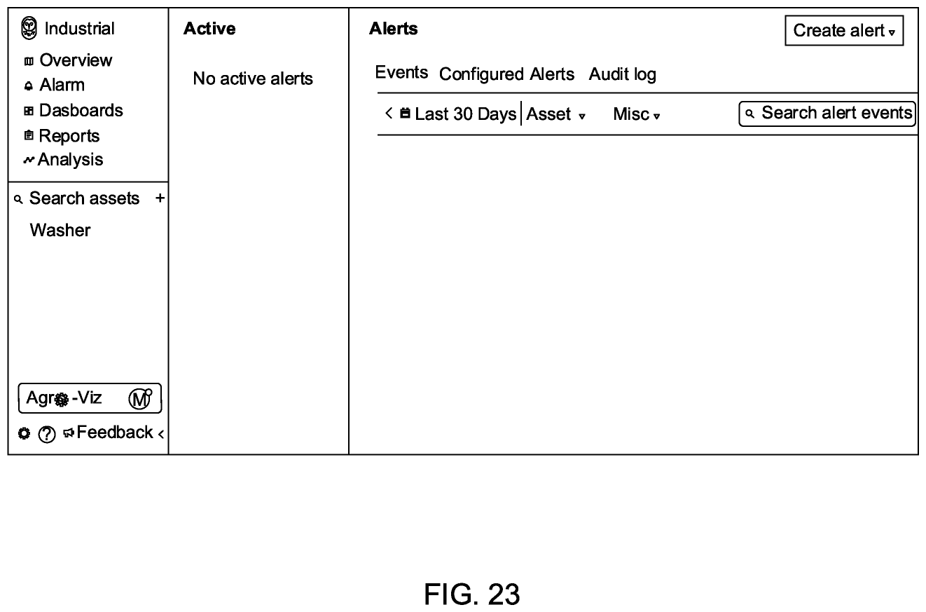

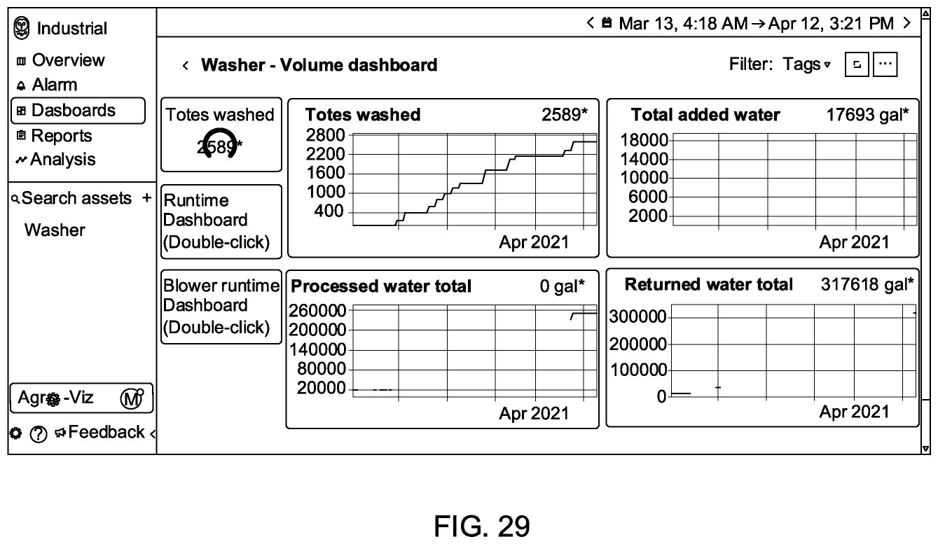

FIGS. 23-31 illustrate various screens of a computerized system that is configured to control and/or provide status information regarding the container wash system. The computerized system may include various user-selectable features, such as, for example, reports on usage, alarms, analysis, and the like. For instance, one or more sensors may be located within the container wash system to provide information such as, without limitation, water usage, flow rates, hours of operation of the system, the number of containers processed by the system, the feed rate of the conveyor belts, the air flow rate, water pressure, amount of collected sediment, the volume of reclaimed water, the number of times the water inventory has been circulated through the system, the location of the container wash system, among other things. The computerized system may provide automated alerts based upon any of a number of factors, such as, for example, upon statistics, run time, flow rates, fluid pressure, number of processed containers, among others. The alerts may provide information, such as when to replace or clean a component of the container wash system, such as the water inventory, one or more filters, a fluid pipe or nozzle, or some other component.

FIG. 23 illustrates an example user interface screen that may be presented on a display of a computing device to provide information and/or control of the systems described herein. FIG. 23 may present a screen showing one or more alerts associated with the systems of the container wash system, and may include any type of alert, such as water volume, water pressure, water temperature, federate, throughput, or other environmental data, sensor data, or other information associated with the container wash system.

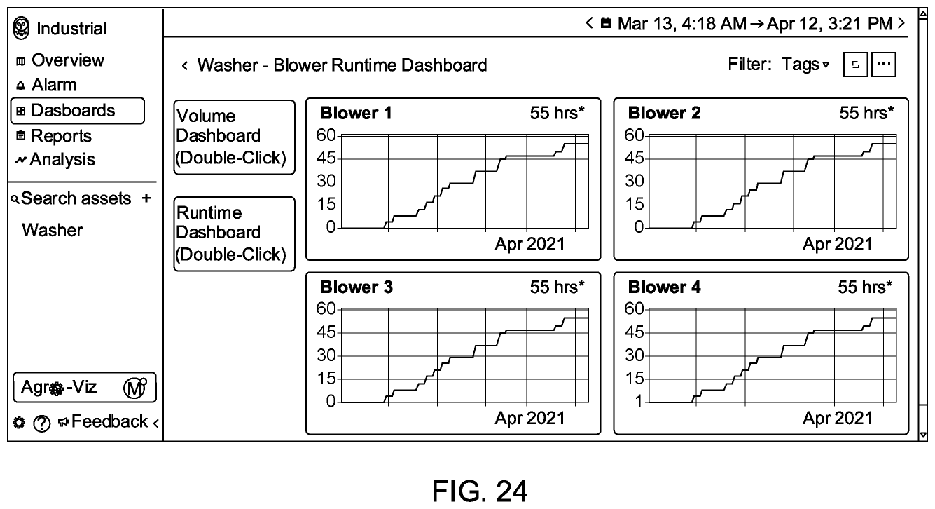

FIG. 24 illustrates an example user interface screen that may be presented on a display of a computing device that may provide information and/or control of the systems described herein. For example, a dashboard screen may provide runtime data of one or more blowers. This information may be used, for example, to know when one or more components (e.g., blowers) are reaching their service life and may need to be serviced in the near future, such as to replace vanes, rebuild a motor, or replace the blower entirely. Of course, the runtime of other components may have similar displays, such as to show the runtime for one or more pumps, filters, conveyors, and the like.

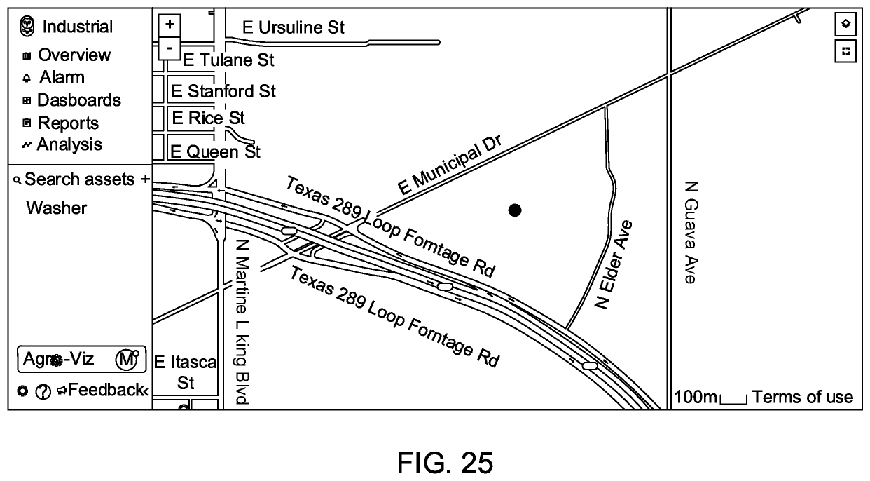

FIG. 25 illustrates an example user interface screen that may be presented on a display of a computing device to provide information and/or control of the systems described herein. In some cases, multiple container wash systems may be deployed, and each may include a tracker, such as a GPS transmitter that can send location data to a centralized system. In some cases, an administrator may log into the system and see the current location of one or more container wash systems. In some cases, either the wash system 100, the energy delivery system 500, or both may include a location transmitter that may broadcast the location of the system.

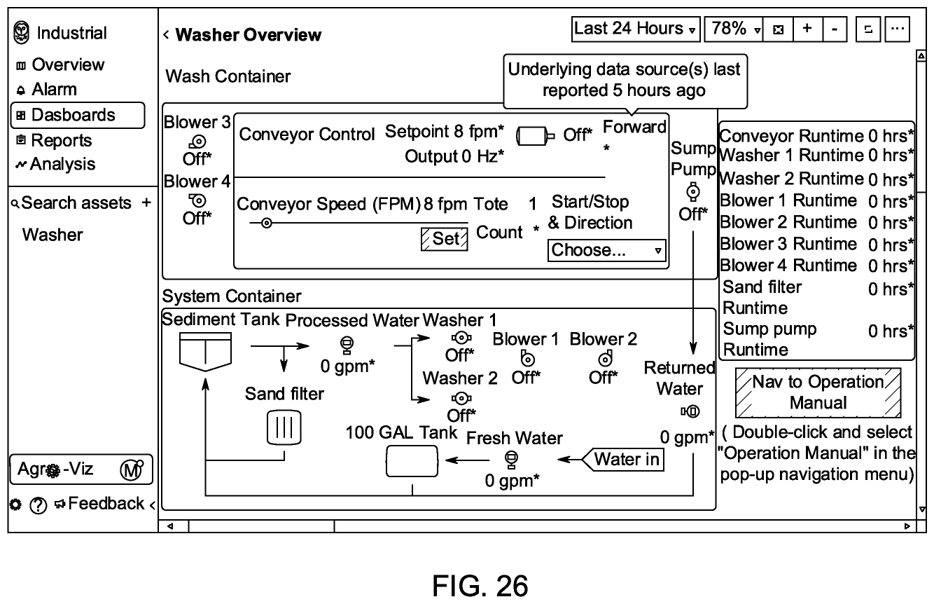

FIG. 26 illustrates an example user interface screen that may be presented on a display of a computing device to provide information and/or control of the systems described herein. In some cases, the conveyor may be controller to vary the throughput of containers through the container wash system. A series of controls may be provided to allow an operator to vary operating conditions of the system, such as conveyor speed, water volume or pressure, fan speed, and control of one or more valves to vary the fluid flow path of the cleaning solution.

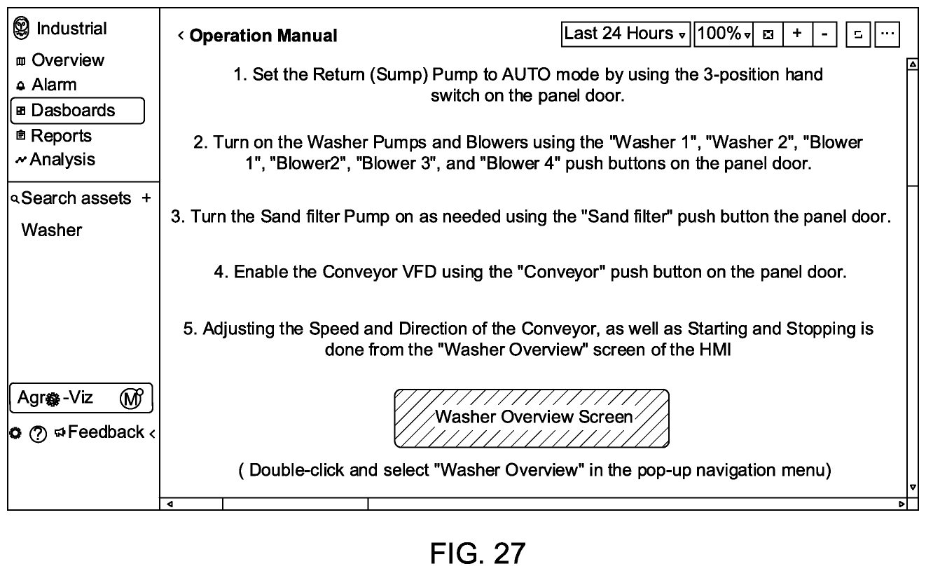

FIG. 27 illustrates an example user interface screen that may be presented on a display of a computing device to provide information and/or control of the systems described herein. In some cases, the display may provide instructions to aid a user in operating the container wash system. The display may include a checklist, and may further allow a user to interact with the display to control the various functions of the container wash system.

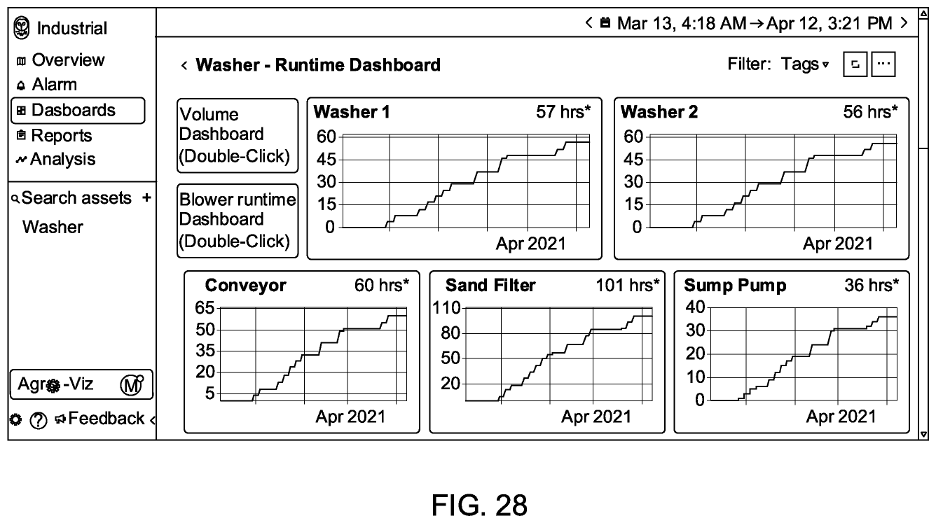

FIG. 28 illustrates an example user interface screen that may be presented on a display of a computing device to provide information and/or control of the systems described herein. In some examples, a runtime of the components may be tracked, which may provide information related to the end of life of a component, or a cleaning schedule, rebuild schedule, or replacement schedule. For instance, the sand filter may cause an alarm at a predetermined runtime that informs a user to backwash the sand filter, replace the cleaning media in the sand filter, or replace the pump that circulates cleaning fluid through the sand filter. Similarly, the runtime dashboard may provide details of other components and may generate alerts when one or more of the components needs servicing.

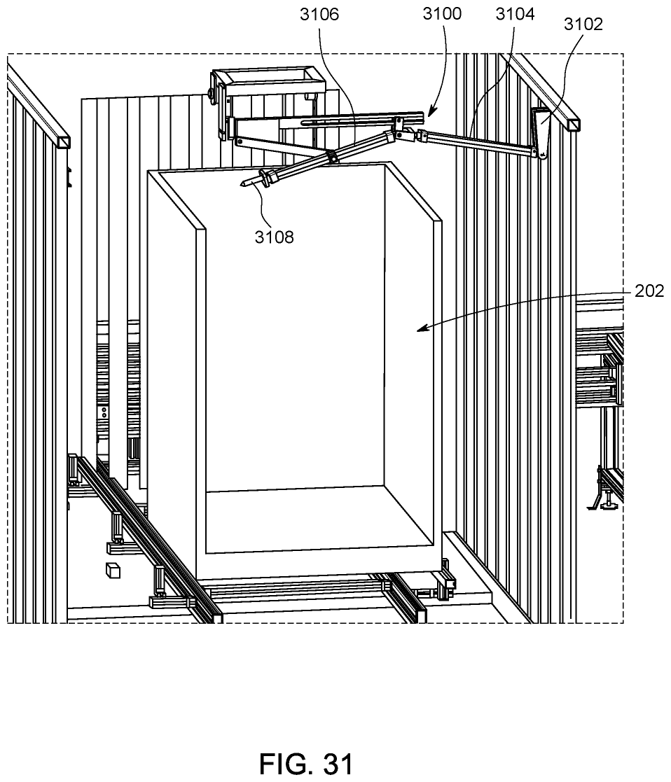

FIG. 31 illustrates an example user interface screen that may be presented on a display of a computing device to provide information and/or control of the systems described herein. A volume dashboard may provide information related to total containers cleaned, the volume of water that has been added, processed, discarded, among other information associated with the container cleaning system.

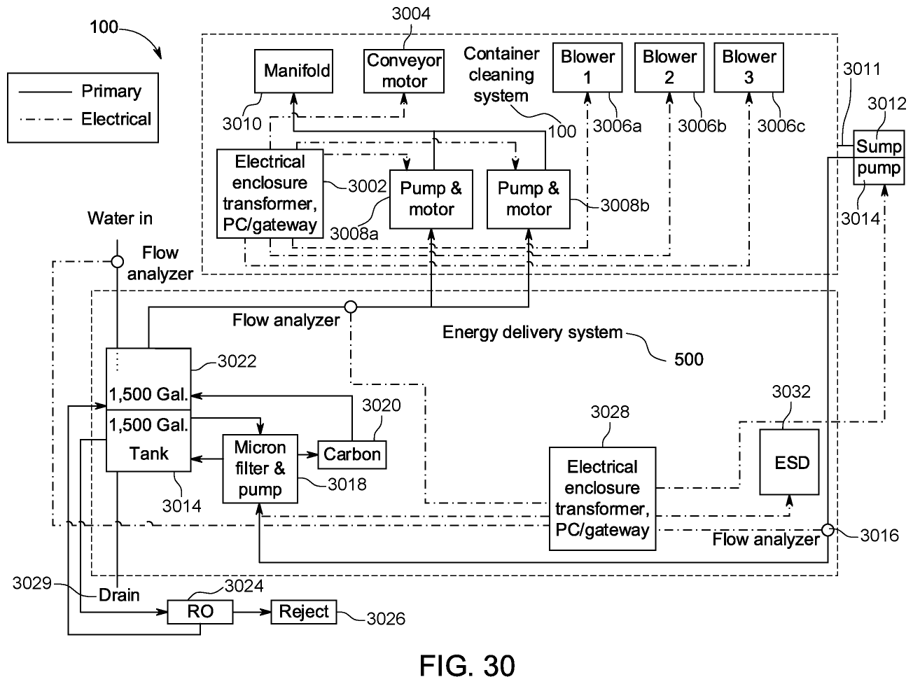

FIG. 30 illustrates a piping and instrumentation diagram according to some embodiments of the container wash system described herein. As with any of the embodiments described throughout this disclosure, any of the components, subsystems, and systems can be interchangeable to result in a customizable container wash system that can be configured for various containers, operating modalities, and outfitted with various pumps, blowers, nozzles, conveyors, and the like.

According to some embodiments, the container wash system 100 is carried in one containment structure and the energy delivery system 500 is carried in a second containment structure. The separate containment structure may facilitate transporting the container washing system 100 to a location for processing one or more containers to be washed. Of course, as has been described, the container wash system 100 and the energy delivery system 500 may be carried in a single containment structure, which may be long, taller, or wider, than either of the individual containment structure when the system are housed in separate containment structures.

The container wash system 100 may be configured as described with reference to any of the embodiments herein. The piping may have any suitable configuration and routing within ten contain cleaning system 100, or between the container cleaning system 100 and the energy delivery system 500. In some examples, the container cleaning system 100 includes an electrical enclosure 3002 in electrical communication with one or more components or subsystems. For instance, the electrical enclosure 3002 may be in electrical and/or control communication with one or more conveyor motors 3004 such as for providing motion to the conveying system for transporting one or more containers through the container cleaning system 100. The electrical enclosure 3002 may also be in communication with one or more blowers 3006a, 3006b, 3006c. The blowers may be any suitable blower, such as those described herein, and the blowers may be suitably configured to drying a container passing through the container cleaning system 100.

The electrical enclosure 3002 may additionally include a controller, which may include one or more processors and be configured with memory having instructions that, when executed by the one or more processors, causes the one or more processors to control the various components, subsystems, and systems of the container wash system 110 and/or the energy delivery system 500. For example, the electrical enclosure 3002 may controller the conveyor motor 3004, the blowers 3006a, one or more pumps 3008a, 3008b, and other components.

In some cases, a fluid flow pathway provides for a washing fluid to be applied to a container passing through the container cleaning system 100. In some cases, the washing fluid is water. The fluid flow pathway may include the pumps 3008a, 3008b, which may include motors to pressurize the cleaning fluid. A manifold 3010 may be provided to direct pressurized cleaning fluid to various outlets positioned about and/or within a container in the container cleaning system 100. The cleaning fluid may pool, via gravity, at the bottom of the container cleaning system 100, which may have a floor that directs the cleaning fluid to an outlet 3011, such as a drain, in the floor of the containment structure. The cleaning fluid may exit the drain 3011 and be collected in a sump 3012 which may have a sump pump 3014. The sump 3012 may be any suitable sump, and in some embodiments, the sump includes a multichambered sump. For example, used cleaning fluid may collect in a first chamber of a sump, and as the fluid level rises, it flows over a divider within the sump that separates a first chamber from a second chamber. Solid particulates carried by the cleaning fluid will have a tendency to settle in the bottom of the first chamber of the sump. The cleaning fluid may pass from the first chamber of the sump to a second chamber of the sump, where particles that escaped the first chamber may be encouraged to settle at the bottom of the second chamber. Similarly, a third chamber, a fourth chamber, or more chambers may be provided to sequentially allow particulate settling in order to remove particulate materials from the cleaning fluid. In some cases, the cleaning fluid is cleaned and recirculated through the container cleaning system 100.

After being processed through the sump 3012, the cleaning fluid may be routed, by a pump 3014, to a micron filter and pump 3018. The cleaning fluid may pass through a flow analyzer 3016 that may measure the flow of the cleaning fluid, the temperature, the cleanliness, or some other characteristic of the cleaning fluid. The cleaning fluid leaving the micron filter and pump 3018 may be sent to an additional filter, such as a carbon filter 3020, or alternatively, may be sent directly to the storage tank 3014. The storage tank 3014 may store water received from the container cleaning system 100 and may further process the cleaning fluid before recirculating the cleaning fluid back to the container cleaning system 100. For example, the cleaning fluid may pass through the micron filter 3018 again before being routed to the carbon filter 3020 and to the clean storage tank 3022. The micron filter 3018 and the carbon filter 3020 may further remove impurities from the cleaning fluid, such as, for example, any fine particles suspended in the cleaning fluid, any chemicals or other contaminants that may have entered the cleaning fluid during the wash cycle. After passing through the micron filter 3018 and/or the carbon filter 3020, the cleaning fluid may be returned to the storage tank 3014, and may be processed again through the micron filter and pump 3018, or may be sent through the carbon filter 3020 and sent to the clean water tank 3022.

In some cases, cleaning fluid may optionally be sent through a reverse osmosis (RO) system 3024 to further clean the cleaning fluid before directing the cleaning fluid to the clean water tank 3022. In some cases, the cleaning fluid may be discarded, such as by discarding the cleaning fluid at the reverse osmosis system 3024 through an RO rejection system 3026, through a drain 3029 coupled to the storage tank 3014, or at another location along the fluid flow path. In some examples, the water may be processed by routing the used water in the storage tank 3014 through the micron filter and pump 3018 one or more times, and then routing the water from the storage tank 3014 through the RO system 3024 and then to the clean water tank 3022.

Processed water, after it has passed through the micron filter 3018, and/or the carbon filter 3020, and/or the RO system 3024, may be sent to the clean water tank 3022 where it can be pumped to the container cleaning system 100 for washing containers. In some examples, the energy delivery system 500 incorporates an electrical enclosure 3030 that may house one or more transformers, computing devices, or other components that provide electrical and/or control communication between the electrical enclosure 3030 and the components, subsystems, and systems of the energy delivery system 500. In some examples, the electrical enclosure is coupled to an emergency shutdown system (ESD) 3032 that may provide a quick way to shut down the energy delivery system 500, the container cleaning system 100, or both. The ESD may include a switch or button that can be activated to disconnect electrical power from one or more of the components serviced by the electrical enclosures 3002, 3028 to quickly stop the container cleaning process.

Additional flow analyzers 3034a, 3034b, may be provided at any suitable location along the fluid flow path and may be configured to measure any characteristic of the cleaning fluid, such as pressure, flow rate, temperature, contaminants, and the like.

In some embodiments, an optional heater may be provided along the fluid flow path, such as in the storage tank 3014, the clean water tank 3022, the sump 3012, or other suitable location. The optional heater may increase the temperature of the cleaning fluid and may be configured to inhibit freezing of the cleaning fluid when the container cleaning system 100 is used in sub-freezing environments. The optional heater may be any suitable heater, such as electrical resistance heater, propane heater, natural gas heater, kerosene heater, solar heater, or other type of cleaning fluid heater. In some cases, the heater may be configured to maintain the cleaning fluid above a threshold temperature, and in some cases, may be automated through the electrical enclosure 3028 and a sensor, such as a thermostat or thermocouple.

FIG. 31 illustrates embodiments of a wash arm 3100 configured to wash the inside of a container. The wash arm 3100 includes a mount 3102 a first linkage 2804 and may optionally include a second linkage 3106. The first linkage 2804 and the second linkage 3106 may be coupled together through any suitable mechanism, such as, without limitation, a hinge, a bearing, a journal, a gear, a slider, or some other structure that allows the second linkage to move relative to the first linkage. The mount 3102 may allow movement between the mount and the first linkage 3104, such as pivotal movement, rotational movement, translational movement, or a combination.

In some cases, the wash arm 3100 may be under the control of one or more processors and can be configured to move in accordance with a preprogrammed wash cycle. A nozzle 3108 may be positioned at or near an end of the second linkage 3106 where a second linkage is provided. In some cases, the nozzle 3108 may be positioned at the end of the first linkage 3104. According to some embodiments, the first linkage 3104 is hollow and defines a fluid flow path through the first linkage 3104 and to the nozzle 3108. The wash arm 3100 may be moveable between a first position (e.g., stowed position), and a second position (e.g., inserted position).

The wash arm 3100 may be actuated at an appropriate time to move between the stowed position and the inserted position. In some cases, when in the stowed position, a container 202 may pass by the wash arm without contacting the wash arm. The wash arm 3100 may be configured such that, when a container 202 passes by the wash arm 3100, the wash arm 3100 actuates and positions the nozzle 3108 inside the container 202 and sprays cleaning fluid through the nozzle 3108 to contact inner walls of the container 202 to clean the inside of the container 202.

In some cases, the wash arm 3100 enters the container 202 from a location above the container 202, such that the wash arm 3100 extends downwardly into the container 202 to position the nozzle 3108 to effectively clean the inside of the container 202. In some examples the container 202 may be positioned such that an opening to the container faces generally downwardly, and the wash arm 3100 may extend upwardly into the container 202 to position the nozzle 3108 for cleaning the inside of the container 202. It should be appreciated that the wash arm may have any configuration, any number of linkages, and any suitable movement such that in a first configuration, the wash arm does not interfere with a container 202 passing thereby, and in a second configuration, the wash arm is able to wash the inside of the container 202. In some cases, the wash arm 3100 moves between the stowed configuration and the inserted configuration to effectuate cleaning of the inside of the container 202.

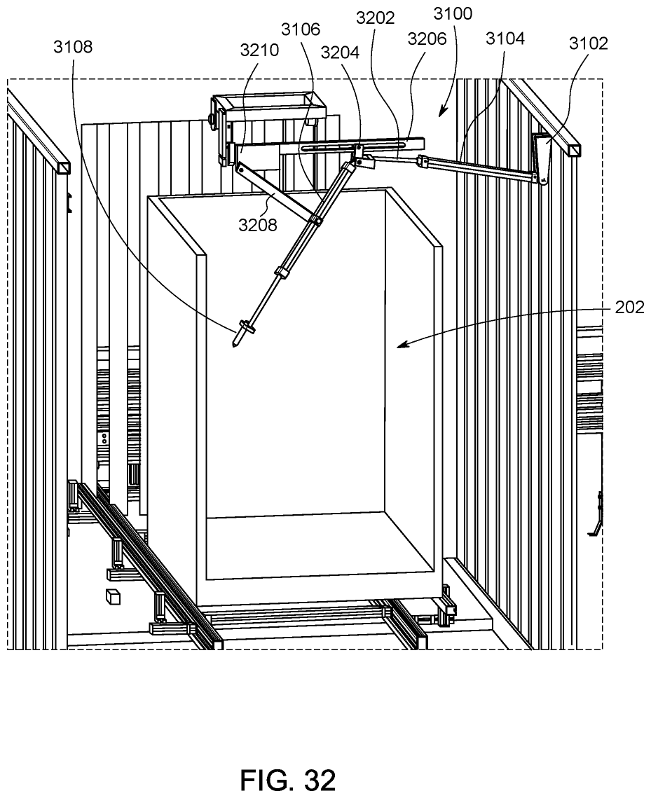

With reference to FIG. 32 the wash arm 3100 is shown in an intermediate position between the stowed position and the inserted position. In some embodiments, the first linkage 3104 includes a linear actuator 3202 that linearly extends a control rod from the first linkage 3104. A coupling 3204 between the first linkage 3104 and the second linkage 3106 may allow the second linkage 3108 to pivot with respect to the first linkage 3106. In some cases, the coupling 3204 may also translate, such as along a track 3206.

A rigid arm 3208 may pivotally couple to the second linkage 3106 and a frame 3210. In some cases, as the linear actuator 3202 extends and moves the coupling 3204 along the track 3206, the rigid arm 3208 causes the second linkage 3106 to pivot with respect to the first linkage 3104. In other words, the linear actuator may cause the nozzle 3108 to move farther away from the mount 3102 and to also rotate about the coupling 3204 to position the nozzle 3108 into the container 202.

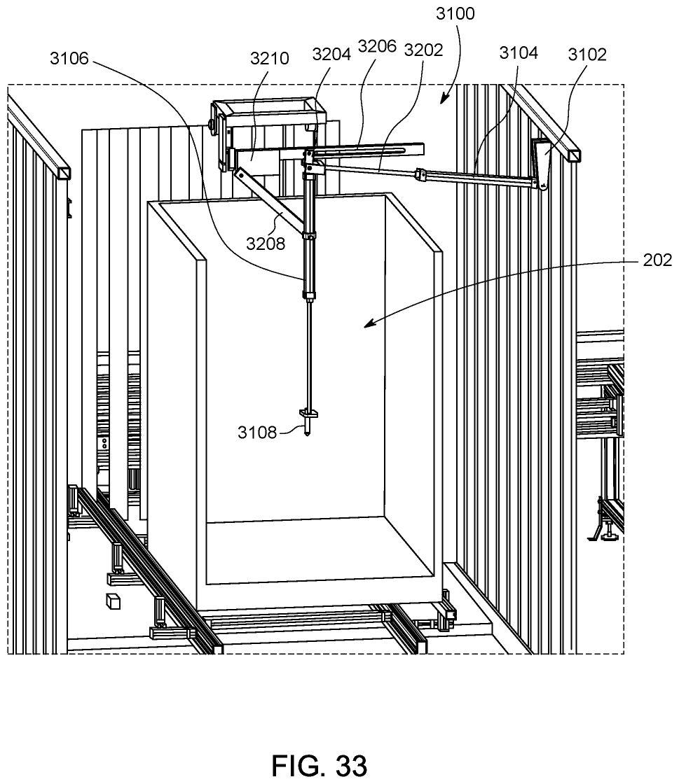

With additional reference to FIG. 33, as the linear actuator 3202 extends the coupling 3204 toward the limit of travel along the track 3206, the rigid arm 3208 causes the second linkage 3106 to be oriented in a substantially vertical orientation. Accordingly, the nozzle 3108 affixed to a distal end of the second linkage 3106 is well within the container 202. Of course, the second linkage 3106 may be oriented in some other orientation in order to position the nozzle 3108 within the container 202 for cleaning the inside of the container 202. The examples shown throughout FIGS. 31-33 are for illustrative purposes.

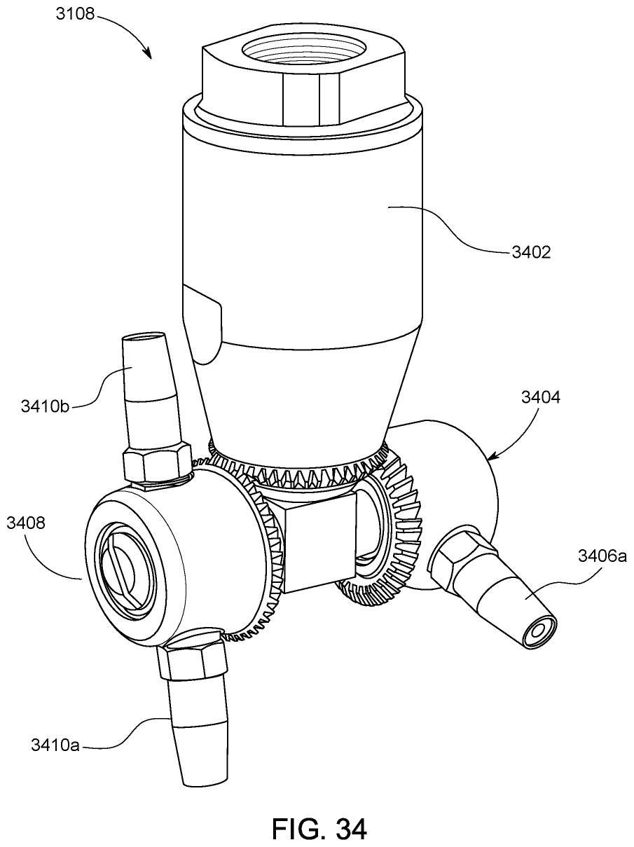

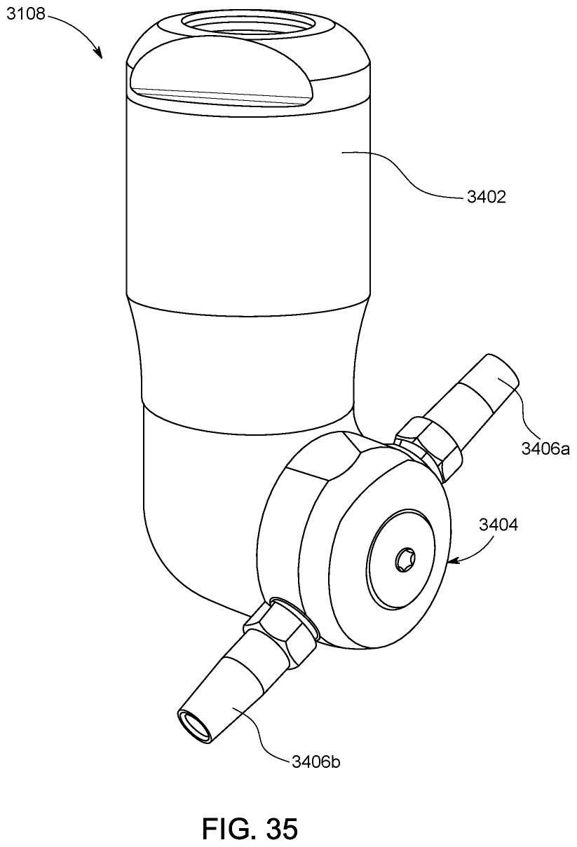

With reference to FIGS. 34 and 35, the nozzle 3108 may be any suitable nozzle 3108 configured for directing a jet of cleaning fluid toward the container 202. A nozzle may have a body 3402 in fluid communication with a cleaning fluid source. For ease of description, water will be used in the description as an example cleaning fluid. The body 3402 may be hollow and be coupled to a first nozzle head 3404. The first nozzle head 3404 may have one or more jets 3406a, 3406b.

In some embodiments, the body 3402 is coupled to a second nozzle head 3408, which may likewise have one or more jets 3410a, 3410b. The first nozzle head 3404 and second nozzle head 3408 may be configured to rotate about an axis of the body 3402. The first nozzle head 3404 may be configured to rotate about an axis of the nozzle head 3404, perpendicular to the axis of the body 3402. Additional nozzle heads, such as the second nozzle head 3408, for example, may be similarly configured. In operation, a pressurized source of water is supplied to the interior of the body 3402 and is directed to the jets 3406a, 3406b, 3410a, 3410b. In some cases, the water pressure causes the body to rotate about its axis, and may also cause the nozzle heads 3404, 3408 to rotate about their respective axes. In this way, when the nozzle 3108 is placed within a container, the rotation of the body 3402 and jets 3406, 3410 will direct pressurized water at all the interior surfaces of the container 202. Of course, other types of nozzles may be provided with embodiments hereof without departing from the spirit and scope of the disclosure.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

As used herein, the terms “about” and “approximately” may, in some examples, indicate a variability of up to ±5% of an associated numerical value, e.g., a variability of up to ±2%, or up to ±1%.

The various exemplary devices and methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of” Finally, for ease of use, the terms “including” and “having” (and their derivatives), as used in the specification and claims, are interchangeable with and shall have the same meaning as the word “comprising.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. A method of washing a container, comprising:
providing a wash system comprising a plurality of water jets carried on a wash frame and disposed within a first containment structure carried on a first trailer;
providing a drying system comprising a plurality of air jets carried on a drying frame disposed within the first containment structure;
providing a conveying system configured to convey a container through the wash system and the drying system;
locating the first trailer at a loading dock of a building to facilitate retrieving a washed container from the conveying system from inside the building; and
placing a container to be washed onto the conveying system and conveying the container through the wash system and the drying system on the conveying system; and
wherein the wash system sprays the container to be washed with the plurality of water jets and wherein the drying system directs moving air at the container to be washed after the wash system sprays the container.

2. The method of claim 1, further comprising moving a spray nozzle from a first location outside the container to be washed to a second location inside the container to be washed and spraying a cleaning fluid through the spray nozzle to clean the inside of the container to be washed.

3. The method of claim 1, further comprising collecting, at a bottom of the containment structure, cleaning fluid that has passed through the plurality of water jets and directing the cleaning fluid to a sump.

4. The method of claim 3, further comprising pumping the cleaning fluid from the sump through a filtration system to result in filtered cleaning fluid.

5. The method of claim 4, further comprising recirculating the filtered cleaning fluid to be used again in the wash system.

6. The method of claim 1, further comprising heating, with a heater, cleaning fluid.

7. The method of claim 1, further comprising providing an energy delivery system and coupling the energy delivery system to the wash system by one or more electrical connections and one or more fluid connections.

8. The method of claim 7, wherein the energy delivery system is disposed within a second containment structure and is carried on a second trailer.

9. The method of claim 1, wherein the conveying system extends from a first location outside the first containment structure, through the containment structure, and to a second location outside the first containment structure.

10. The method of claim 1, further comprising moving a first drying fan from a stowed location inside the first containment structure to an operating location outside the first containment structure.

11. The method of claim 1, further comprising assembling the conveying system by removing portions of the conveying system from the first containment system and coupling the portions of the conveying system together outside the first containment system.

12. The method of claim 1, further comprising flipping a container to be washed from a first orientation to a second orientation.

13. The method of claim 1, further comprising causing the cleaning fluid to pass through a reverse osmosis system.

14. The method of claim 1, further comprising controlling, with one or more processors, one or more of the wash system, the drying system, and the conveying system.

15. The method of claim 14, further comprising displaying, on a display in communication with the one or more processors, information associated with the wash system.

16. The method of claim 15, wherein the information associated with the wash system comprises one or more of a fluid flow rate, a number of containers that have passed through the wash system over a time period, a time of operation, a fluid pressure, a gas pressure, and a fluid temperature.

17. The method of claim 1, wherein the conveying system defines an ingress path that is adjacent the loading dock to facilitate loading the container to be washed from the building to the conveying system, an intermediate path that passes the container to be washed through the wash system and the drying system, and an egress path that is adjacent to the loading dock to return the container to be washed to the building.
